(19) United States
(12) Patent Application Publication
(10) Pub. No.: US 2026/0368325 A1
(43) Pub. Date: Nov. 19, 2026

(54) PROVER DEVICE AND REMOTE ATTESTATION SYSTEM

(71) Applicant: DENSO CORPORATION, Kariya-city (JP)

(72) Inventors: Madoka ASAI, Kariya-city (JP); Hirofumi YAMASHITA, Kariya-city (JP); Motonori ANDO, Kariya-city (JP); Hiromichi NEGISHI, Kariya-city (JP); Ameer KASHANI, Southfield, MI (US); Carlos MORA-GOLDING, Southfield, MI (US)

(21) Appl. No.: 19/206,423

(22) Filed: May 13, 2025

(51) Int. Cl. G06F 21/57

(52) U.S. Cl. CPC G06F 21/57; G06F 2221/033

(57) ABSTRACT

A prover device in a remote attestation system including a prover device and a verification device is provided. The prover device includes: a measurement unit configured to execute measurement using detection of a security event by a security sensor as a trigger; a measurement result transmission unit configured to transmit a measurement result by the measurement unit to the verification device; an evidence collection instruction reception unit configured to receive an evidence collection instruction requesting evidence data from the verification device receiving the measurement result; and an evidence data transmission unit configured to transmit the evidence data to the verification device based on the evidence collection instruction.

### TECHNICAL FIELD

The present disclosure relates to a prover device for executing software measurement in a remote attestation system that verifies, with a verification device, the integrity of software executed with the prover device. As an example, the present disclosure relates to a remote attestation system in which all or some devices constituting the system are mounted on a vehicle.

### BACKGROUND

Related art discloses a remote attestation scheme that verifies the integrity of processes and systems in execution. In the related art, a prover acquires a start address, a size, and a measurement result of a process or a system memory region and transmits these to a verifier. The verifier verifies the integrity of the prover by comparing a correct value prepared in advance or a correct value calculated based on the received information with the received measurement result.

### SUMMARY

According to an aspect of the present disclosure, a prover device in a remote attestation system including a prover device and a verification device is provided. The prover device may include: a measurement unit configured to execute measurement using detection of a security event by a security sensor as a trigger; a measurement result transmission unit configured to transmit a measurement result by the measurement unit to the verification device; an evidence collection instruction reception unit configured to receive an evidence collection instruction requesting evidence data from the verification device receiving the measurement result; and an evidence data transmission unit configured to transmit the evidence data to the verification device based on the evidence collection instruction.

### BRIEF DESCRIPTION OF DRAWINGS

The objects, features, and advantages of the present disclosure will become more apparent from the following detailed description made with reference to the accompanying drawings. In the drawings:

FIG. 1A is an explanatory diagram illustrating the arrangement of a prover device, a verification device, and a remote attestation system;

FIG. 1B is an explanatory diagram illustrating the arrangement of the prover device, the verification device, and the remote attestation system;

FIG. 1C is an explanatory diagram illustrating the arrangement of the prover device, the verification device, and the remote attestation system;

FIG. 2 is an explanatory diagram illustrating the arrangement of the prover device and the verification device in a vehicle and a configuration example of an electronic control system;

FIG. 3 is a diagram illustrating a security log generated by a security sensor of each embodiment;

FIG. 4 is a block diagram illustrating a configuration example of a prover device according to a first embodiment;

FIG. 5 is an explanatory diagram illustrating processing content in a measurement unit;

FIG. 6 is an explanatory diagram illustrating a measurement result transmitted from the prover device to a verification device;

FIG. 7 is a block diagram illustrating a configuration example of the verification device according to the first embodiment;

FIG. 8 is an explanatory diagram illustrating information stored in advance in a storage unit of the verification device;

FIG. 9 is an explanatory diagram illustrating an evidence request instruction transmitted from the verification device to the prover device;

FIG. 10 is an explanatory diagram illustrating evidence data transmitted from the prover device to the verification device;

FIG. 11 is a flowchart illustrating the operation of a remote attestation system according to the first embodiment;

FIG. 12 is a block diagram illustrating a configuration example of a prover device according to a second embodiment;

FIG. 13 is a block diagram illustrating a configuration example of a verification device according to the second embodiment;

FIG. 14 is a flowchart illustrating the operation of a remote attestation system according to the second embodiment;

FIG. 15 is a flowchart illustrating the operation of the remote attestation system according to the second embodiment;

FIG. 16 is a block diagram illustrating a configuration example of a prover device according to a third embodiment;

FIG. 17 is a block diagram illustrating a configuration example of a verification device according to the third embodiment;

FIG. 18 is a flowchart illustrating the operation of a remote attestation system according to the third embodiment;

FIG. 19 is a flowchart illustrating the operation of the remote attestation system according to the third embodiment;

FIG. 20 is a block diagram illustrating a configuration example of a prover device according to a fourth embodiment;

FIG. 21 is an explanatory diagram illustrating a measurement instruction received by a measurement instruction reception unit according to the fourth embodiment;

FIG. 22 is a block diagram illustrating a configuration example of a verification device according to the fourth embodiment;

FIG. 23 is an explanatory diagram illustrating a measurement instruction transmitted from the verification device to the prover device according to the fourth embodiment;

FIG. 24 is a flowchart illustrating the operation of a remote attestation system according to the fourth embodiment;

FIG. 25 is a block diagram illustrating a configuration example of a verification device according to a modification;

FIG. 26 is an explanatory diagram illustrating a measurement instruction transmitted from the verification device according to the modification to the prover device; and

FIG. 27 is a flowchart illustrating the operation of a remote attestation system according to the modification.

### DETAILED DESCRIPTION

In recent years, various electronic control devices connected by an in-vehicle network are mounted on an automobile, and software is executed in each electronic control device. However, there is a possibility that such software may be tampered with by a cyberattack or the like due to being compromised, causing the software to operate differently from the original plan. To solve such a problem, the use of remote attestation is being considered. Remote attestation is a mechanism that can confirm the integrity of a device or software on the device during remote operation or the like for the purpose of device management and operation.

Here, the present inventor has found the following problems as a result of detailed studies.

In the remote attestation disclosed in the related art, a device or software on the device is reset or evidence is concealed by an attacker from the time a cyberattack occurs until the prover executes measurement, so that tampered software data may be lost.

Therefore, the present disclosure provides a prover device and a remote attestation system that can acquire a measurement result necessary for integrity verification before tampered software data is lost by executing measurement using detection of a security event by a security sensor as a trigger.

According to one aspect of the present disclosure, a prover device in a remote attestation system including a prover device and a verification device is provided. The prover device includes a measurement unit configured to execute measurement using detection of a security event by a security sensor as a trigger; a measurement result transmission unit configured to transmit a measurement result by the measurement unit to the verification device; an evidence collection instruction reception unit configured to receive an evidence collection instruction requesting evidence data from the verification device receiving the measurement result; and an evidence data transmission unit configured to transmit the evidence data to the verification device based on the evidence collection instruction.

With the above configuration, the prover device or the like according to the present disclosure executes measurement necessary for verification in remote attestation when a security event is detected. Therefore, a measurement result necessary for integrity verification can be obtained before tampered software data is lost.

Hereinafter, embodiments of the present disclosure will be described with reference to the drawings.

When there are a plurality of embodiments (including modifications; the same applies hereinafter in this paragraph), the configuration disclosed in each embodiment is not limited to that embodiment and can be combined with configurations of other embodiments. For example, the configuration disclosed in one embodiment may be combined with another embodiment. The configurations disclosed respectively in a plurality of embodiments may be collected and combined.

### 1. Premise of Each Embodiment

### (1) Arrangement of Prover Device, Verification Device, and Remote Attestation System

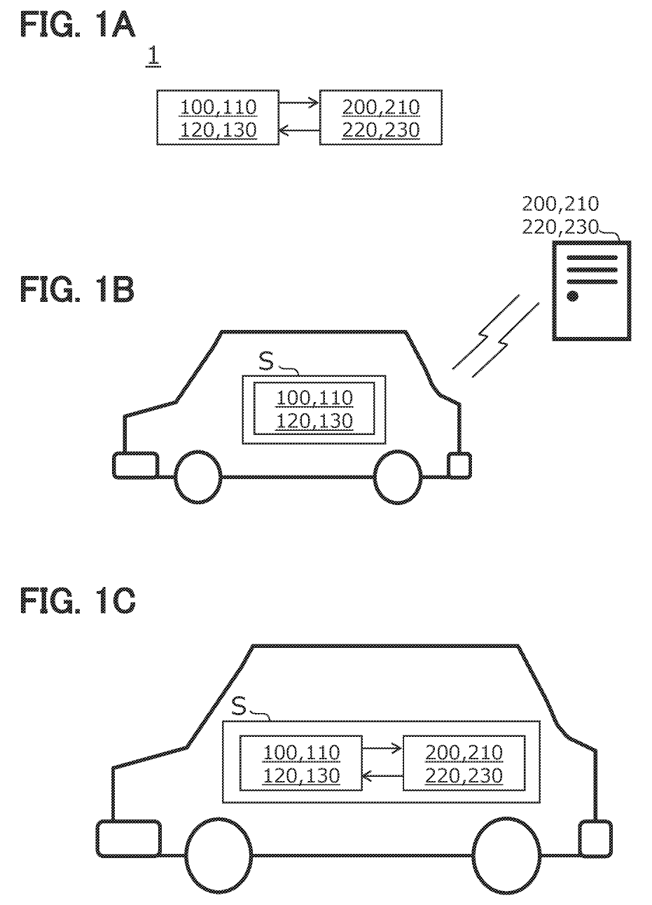

FIGS. 1A, 1B, and 1C are diagrams illustrating arrangement of prover devices 100, 110, 120, 130, verification devices 200, 210, 220, 230, and a remote attestation system 1. Hereinafter, the prover devices 100, 110, 120, 130 are collectively referred to as the prover device 100 or the like, and the verification devices 200, 210, 220, 230 are collectively referred to as the verification device 200 or the like. First, an outline of each device and its connection method will be described with reference to FIG. 1A.

The prover device 100 or the like is a device in which “software” is placed in “memory” to execute the software. This device is a device that is a target for proving the integrity of software executed, that is, a device that provides evidentiary information for proving its own integrity. Therefore, the device is referred to as a prover device.

The verification device 200 or the like is a device that verifies the integrity of “software” executed in the prover device 100 or the like, that is, a device that verifies the integrity of the prover device based on the evidentiary information received from the prover device. Therefore, the device is referred to as a verification device.

The prover device 100 or the like and the verification device 200 or the like are collectively referred to as the remote attestation system 1.

Here, the “software” includes not only a case where the software is made up of program code and data but also a case where the software is made up of only program code or only data.

For the “memory”, a position-identifiable readable/writable recording medium is sufficient, which may include nonvolatile memory such as flash memory or a hard disk, in addition to volatile memory such as random-access memory.

The prover device 100 or the like and the verification device 200 or the like are connected using a wired communication method or a wireless communication method to transmit and receive a measurement result, an evidence collection instruction, evidence data, a measurement instruction, and the like, which will be described later.

Examples of the wired communication method include the Internet, a fixed telephone line, and Ethernet (registered trademark). When an in-vehicle network is used, a controller area network (CAN) or a local interconnect network (LIN) can be used.

Examples of the wireless communication method include IEEE802.11 (Wi-Fi (registered trademark)), IEEE802.16 (WiMAX (registered trademark)), wideband code division multiple access (W-CDMA), high-speed packet access (HSPA), long-term evolution (LTE), long-term evolution advanced (LTE-A), fourth generation (4G), fifth generation (5G), and the like. In addition, dedicated short-range communication (DSRC), Bluetooth low energy (BLE), or Bluetooth (registered trademark) may be used.

As to which communication method to use, it is sufficient to adopt an optimal communication method in accordance with the positions at which the prover device 100 or the like and the verification device 200 or the like are installed, the distance therebetween, and other factors.

The communication between the prover device 100 or the like and the verification device 200 or the like is desirably protected by a secure communication protocol such as mTLS.

The positions where the prover device 100 or the like and the verification device 200 or the like are disposed are arbitrary. That is, the positions of the prover device 100 or the like and the verification device 200 or the like and the distance between the prover device 100 or the like and the verification device 200 or the like are arbitrary.

For example, as illustrated in FIG. 1B, the prover device 100 or the like may be mounted on a vehicle, and the verification device 200 or the like may be provided outside the vehicle. For example, the prover device 100 or the like may be an “electronic control device” (electric control unit, ECU) “mounted” on a vehicle that is a “mobile body”, and the verification device 200 or the like may be a server device installed outside the vehicle that is the “mobile body”. That is, the prover device 100 or the like is located inside an electronic control system S, and the verification device 200 or the like is located outside the electronic control system S. The electronic control device is a device constituting the electronic control system of the vehicle. In this case, the prover device 100 or the like and the verification device 200 or the like are connected by, for example, Wi-Fi or 5G.

Alternatively, as illustrated in FIG. 1C, both the prover device 100 or the like and the verification device 200 or the like may be mounted on the vehicle. For example, the prover device 100 or the like may be an “electronic control device” “mounted” on the vehicle that is the “mobile body”, and the verification device 200 or the like may be another “electronic control device” “mounted” on the vehicle that is the “mobile body”. That is, both the prover device 100 or the like and the verification device 200 or the like are located inside the electronic control system S. In this case, the prover device 100 or the like and the verification device 200 or the like are connected by Ethernet or CAN.

In addition, both the prover device 100 or the like and the verification device 200 or the like may be provided outside the vehicle, regardless of which vehicle.

Here, the “mobile body” refers to a movable object, and a moving speed is arbitrary. Naturally, a case where the mobile body is stopped is also included. Examples thereof include, but are not limited to, an automobile, a motorcycle, a bicycle, a pedestrian, a ship, an aircraft, and an object mounted thereon.

The term “mounted” includes not only a case where the device is directly fixed to the mobile body but also a case where the device is not fixed to the mobile body but moves together with the mobile body. Examples thereof include a case where a person on the mobile body carries the device and a case where the device is mounted on a load placed on the mobile body.

The “electronic control device” may be a virtualized electronic control device implemented using virtualization technology, in addition to a physically independent electronic control device.

In each embodiment to be described later, a description will be given on the premise of the arrangement of FIG. 1B.

### (2) Arrangement of Prover Device 100 or the Like and Verification Device 200 or the Like in Vehicle

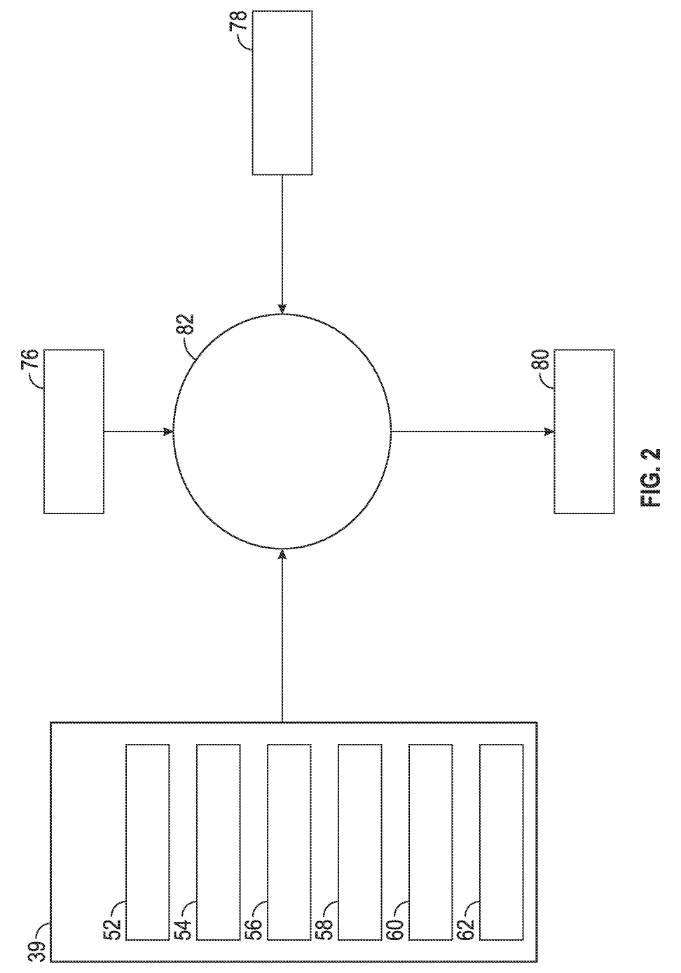

FIG. 2 is a diagram illustrating the electronic control system S mounted on the vehicle and an example of the arrangement of the prover device 100 or the like and the verification device 200 or the like in the electronic control system S.

The electronic control system S includes a plurality of ECUs 50 and an in-vehicle network that connects these ECUs. FIG. 2 illustrates eight ECUs (an ECU 50a to an ECU 50h), but naturally, the electronic control system S includes any number of ECUs. In the following description, the ECU 50 or each ECU 50 is used to collectively describe one or more electronic control devices as a whole, and the ECU 50a, ECU 50b, ECU 50c, ... are used to identify and describe individual electronic control devices.

In the case of FIG. 2, the ECUs 50 are connected via an in-vehicle communication network such as a controller area network (CAN) or a local interconnect network (LIN). Alternatively, the connection may be made using any wired or wireless communication method, such as Ethernet (registered trademark), Wi-Fi (registered trademark), or Bluetooth (registered trademark).

The connection refers to a state where data can be exchanged and includes not only a case where different pieces of hardware are connected via a wired or wireless communication network, but also a case where virtual ECUs (also referred to as virtual machines) implemented on the same hardware are connected to each other virtually.

The electronic control system S illustrated in FIG. 2 includes an integrated ECU 50a, an external communication ECU 50b, zone ECUs (50c, 50d), and individual ECUs (50e to 50h).

The integrated ECU 50a is an ECU equipped with a function to control the entire electronic control system S and a gateway function to mediate communication between the ECUs 50. The integrated ECU 50a may also be referred to as a gateway ECU (G-ECU) or a mobility computer (MC). The integrated ECU 50a may be a relay device or a gateway device.

The external communication ECU 50b is an ECU including a communication unit that communicates with an external device 60 provided outside the vehicle. The communication method used by the external communication ECU 50b is the wireless communication method or the wired communication method described in FIGS. 1A, 1B, and 1C.

To implement a plurality of communication methods, a plurality of external communication ECUs 50b may be provided. Instead of providing the external communication ECU 50b, the integrated ECU 50a may include the function of the external communication ECU 50b.

The zones ECUs (50c, 50d) are ECUs equipped with gateway functions appropriately disposed in accordance with the arrangement places and functions of the individual ECUs (50e to 50h). For example, the zone ECU 50c is an ECU with a gateway function that mediates communication between the individual ECU 50e and the individual ECU 50f arranged in the front of the vehicle and another ECU 50. The zone ECU 50d is an ECU with a gateway function that mediates communication between the individual ECU 50g and the individual ECU 50h arranged in the rear of the vehicle and another ECU 50.

The individual ECUs (50e to 50h) can be configured by ECUs with any function. Examples thereof include: a drive system electronic control device that controls the engine, steering wheel, brake, and the like; a vehicle body system electronic control device that controls the meter, power window, and the like; an information system electronic control device such as a navigation device; and a safety control system electronic control device that performs control to prevent collision with obstacles or pedestrians. The ECUs 50 may not be arranged in parallel, and may be classified into a master and a slave.

Each ECU 50 stores software corresponding to its function and reads the software into memory for execution as necessary. Accordingly, each ECU 50 can be the prover device 100 or the like.

In the following embodiment, a case where the external communication ECU 50b is the prover device 100 or the like in FIG. 2 will be described as an example. This is because the external communication ECU 50b is located in the shallowest layer in the electronic control system and is thus vulnerable to attack and at high risk of program rewriting, so that the external communication ECU 50b often acts as a prover device.

When the verification device 200 or the like is provided outside the vehicle as illustrated in FIG. 1B, the external device 60 of FIG. 2 is the verification device 200 or the like. When the verification device 200 or the like is mounted on the vehicle as illustrated in FIG. 1C, for example, the integrated ECU 50a can be set as the verification device 200 or the like.

In the following embodiment, in FIG. 2, a case where the external device 60 is the verification device 200 or the like will be described as an example.

In the electronic control system S of FIG. 2, a security sensor (abbreviated as SS in the drawing) is provided in each of the ECUs 50, except for the ECU 50h. As described above, it is not necessary to provide the security sensor in all the ECUs 50 constituting the electronic control system S.

When the security sensor mounted on each ECU 50 detects an abnormal security event that has occurred in the ECU 50 or on an in-vehicle communication network to which the ECU 50 is connected, the security sensor generates a security log indicating that the security event has occurred. The security sensor transmits the generated security log to the prover device 100 or the like.

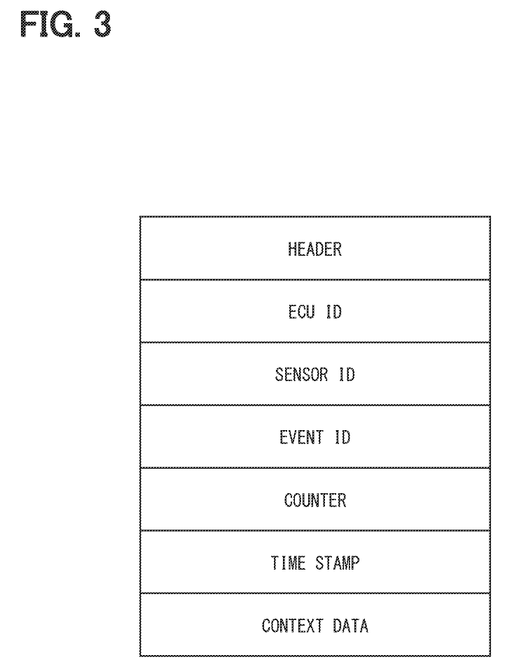

FIG. 3 is a diagram illustrating a specific example of the security log generated by the security sensor. The security log includes respective fields of the following: an ECU identification (ID) (ECUID) indicating identification information of the ECU 50 on which the security sensor is mounted; a sensor ID indicating identification information of the security sensor; an event ID indicating identification information of the security event; a counter indicating the number of occurrences of the event; a timestamp indicating the occurrence time of the event or the generation time of the log; and context data indicating details of output from the security sensor. The security log may further include a header storing information indicating a protocol version and the state of each field.

### 2. First Embodiment

### (1) Configuration of Prover Device 100

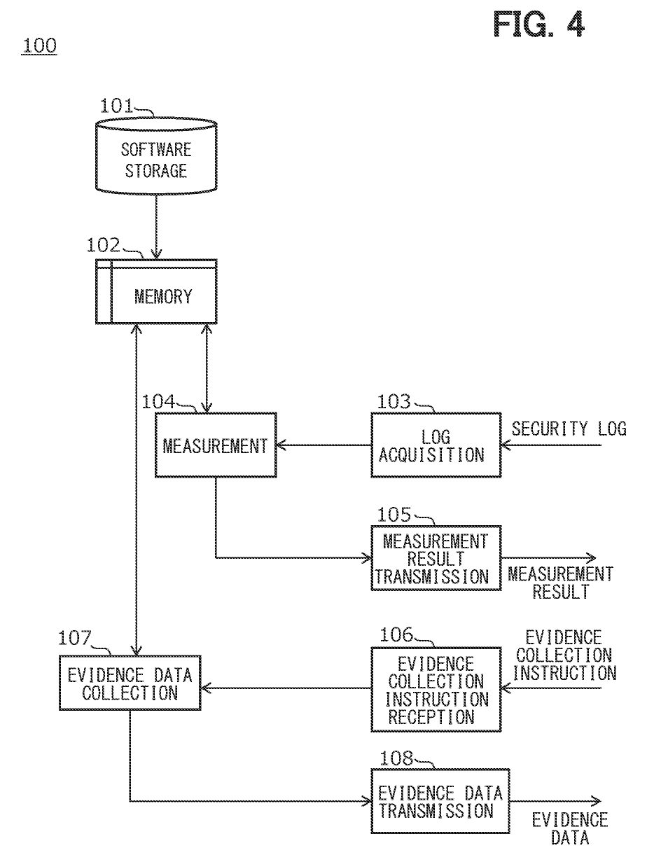

A configuration example of the prover device 100 according to the present embodiment will be described with reference to FIG. 4. The prover device 100 includes a software storage unit 101, a memory 102, a log acquisition unit 103, a measurement unit 104, a measurement result transmission unit 105, an evidence collection instruction reception unit 106, an evidence data collection unit 107, and an evidence data transmission unit 108.

The prover device 100 can include a general-purpose central processing unit (CPU), volatile memory such as random-access memory (RAM), nonvolatile memory such as read-only memory (ROM), flash memory, or a hard disk, various interfaces, and internal bus that connects these components. By executing software on these pieces of hardware, it is possible to perform the functions of the functional blocks illustrated in FIG. 4. The same applies to the verification device 200 to be described later.

The prover device 100 reads the software stored in the software storage unit 101 into the memory 102 to place the software in the memory and execute the software. The placement position of the software in the memory may be either the same at all times or different at each reading. When the position is different for each reading, it is desirable to share the placement position with the verification device 200. When the memory 102 is a random-access memory (RAM), the placement position can be indicated by, for example, a start address indicating the leading position of the software and the size of the software. The size of the software may be omitted when the size of the software is known in the verification device 200. Alternatively, the placement position may be a start address indicating the leading position and an end address indicating the trailing position.

The log acquisition unit 103 acquires the security log generated by the security event from the security sensor provided in the ECU 50.

The measurement unit 104 executes measurement by reading software placed in the memory 102 and calculating a measurement value with detection of a security event by the security sensor as a “trigger”. The measurement unit 104 of the present embodiment executes measurement triggered by the log acquisition unit 103 acquiring the security log as the trigger for executing measurement.

Here, the “trigger” includes not only detection of a security event as a direct trigger, but also an event caused by detection of a security event as a trigger.

The measurement unit 104 of each embodiment calculates a hash value as a measurement value. The hash value is an output value itself calculated by a function that calculates a unique value for an input value, or a value obtained by performing processing such as encryption on the output value, and an algorithm used for the function is arbitrary. For example, the hash values may include not only a value calculated by a one-way hash function such as SHA512 but also a value calculated by a cipher-based MAC (CMAC), a value calculated by a hash-based MAC (HMAC), and a signature.

The measurement unit 104 determines a measurement target, which is a target to be measured in the software, based on the content of the security log. For example, measurement target information indicating a software measurement target is associated in advance with ECUID, a sensor ID, or an event ID that may be included in the security log. The measurement target indicated by the measurement target information associated with the ECUID, the sensor ID, or the event ID included in the security log acquired by the log acquisition unit 103 is determined as the measurement target for which the hash value is calculated. The measurement target information may be any information that can specify all or a part of the software in the memory as the measurement target, and examples thereof include an address and a size.

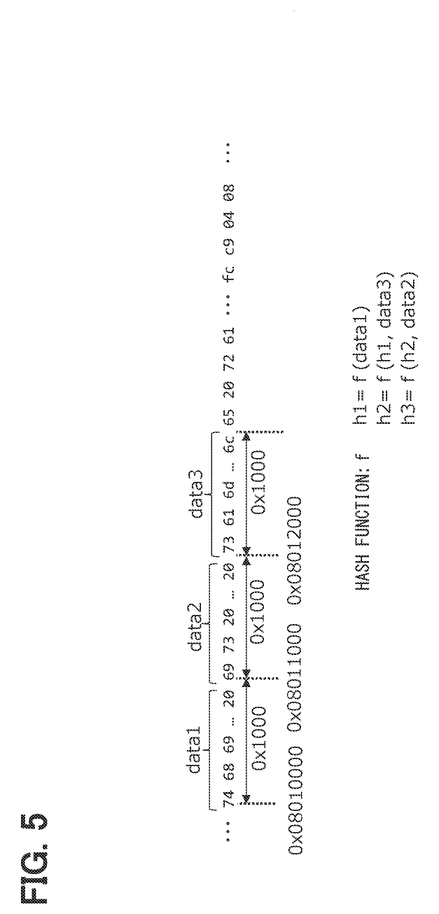

Measurement by the measurement unit 104 will be described with reference to FIG. 5. FIG. 5 is a diagram schematically illustrating software placed in the memory 102. According to FIG. 5, data1 of the software placed in the memory 102 has a start address of 0x08010000 (hexadecimal notation) and a size of 0x1000 (hexadecimal notation), data3 has a start address of 0x08012000 (hexadecimal notation) and a size of 0x1000 (hexadecimal notation), and data2 has a start address of 0x08011000 (hexadecimal notation) and a size of 0x1000 (hexadecimal notation). Therefore, based on the respective arguments, the measurement unit 104 reads the ranges of the software corresponding to the measurement target and calculates the respective hash values as follows:
h1 = f(data1)
h2 = f(h1, data3)
h3 = f(h2, data2)
(where f is a hash function).

The start address may be included as the argument of the hash function.

In FIG. 5, as an example, the software has been divided into three regions to calculate the hash value, but the measurement unit 104 may use raw data of the software on the memory 102 to calculate the hash value. Information indicating whether the software is divided into a plurality of regions to calculate the hash value may also be included in the measurement target information.

The measurement unit 104 may further determine whether to execute measurement based on the content of the security log. For example, when a security event is detected by a specific ECU 50 or the security sensor, the measurement unit 104 determines not to execute measurement. Along with the security sensor, the ECU may be provided with a defense function that blocks unauthorized access when an abnormality such as unauthorized access is detected. When such a defense function is provided, the security sensor detects a security event and generates a security log, but it is not always necessary to perform remote attestation because software tampering due to unauthorized access can be prevented by the defense function. Therefore, when the ECUID or the sensor ID included in the security log indicates the security sensor or the ECU 50 provided with the defense function, the measurement unit 104 determines not to execute measurement.

As another example, the measurement unit 104 may determine that the measurement unit 104 does not execute measurement when the same security sensor detects security events a predetermined number of times or more within a predetermined period. Since the measurement executed by the measurement unit 104 has a high processing load, if measurement is executed many times in a short period of time, the resources of the prover device 100 may be exhausted. There is also a possibility that an attacker may conduct an attack to intentionally generate a security event for the purpose of causing the prover device 100 to execute measurement at a high frequency. Therefore, when the same security sensor detects security events a predetermined number of times or more within a predetermined period, the measurement unit 104 determines not to execute measurement, thereby reducing the processing load of the prover device 100.

As still another example, when the security event detected by the security sensor is a security event in which software or the like is not tampered with, the measurement unit 104 may determine not to execute measurement. For example, in the case of an attack that reads data of software or the like but does not write data, it is not always necessary to perform remote attestation because the software is not tampered with. Therefore, when the event ID included in the security log indicates a security event that is an attack that only reads a memory or a DoS attack that only makes a request to a device, the measurement unit 104 determines not to execute measurement.

Returning to FIG. 4, the measurement result transmission unit 105 transmits a first hash value, which is the hash value calculated and obtained by the measurement unit 104, to the verification device 200 as a measurement result. In the case of FIG. 5, the measurement result transmission unit 105 transmits the hash values h1, h2, h3. In addition to the hash value, the measurement result transmission unit 105 also transmits information specifying the measurement target used for calculation of the hash value. This is because, when the verification device 200 performs verification to be described later, the prover device 100 needs to specify the measurement target used for calculation of the hash value. As information specifying the measurement target used to calculate the hash value, in addition to the address and size of the measurement target, information on the security log used by the measurement unit 104 to determine the measurement target may be transmitted.

The measurement result transmission unit 105 may further transmit the time when the hash value was obtained and error information indicating the address and size of the region to be measured for which measurement has failed.

In the present embodiment, the hash values h1, h2, h3 are simultaneously transmitted. However, since h1 and h2 are reflected in the calculation result of h3, h3 may be first transmitted, and h2 and h1 may be sequentially transmitted as necessary.

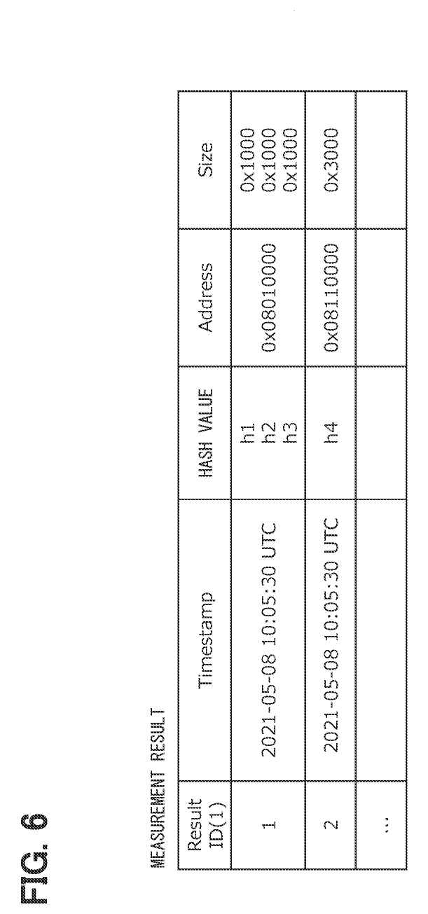

A specific example of the measurement result transmitted by the measurement result transmission unit 105 will be described with reference to FIG. 6. In the example of FIG. 6, the measurement result transmitted by the measurement result transmission unit 105 includes an identifier (Result ID (1)) of the measurement result, the time when the prover device 100 calculated or transmitted the measurement result (Timestamp), the first hash value that is the measurement result, and the start position (Address) of the software in the memory and the size (Size) of the software as measurement target information for specifying the software measurement target used to calculate the first hash value. In the example of FIG. 6, the measurement results are three hash values of h1, h2, and h3. In addition, the measurement result may include a process ID (PID) of software being executed in the prover device 100.

Based on the measurement result transmitted from the measurement result transmission unit 105, the evidence collection instruction reception unit 106 receives the evidence collection instruction generated by the verification device 200. For example, when the verification device 200 detects tampering with software being executed in the memory 102 of the prover device 100, the verification device 200 generates and transmits to the prover device 100, an evidence collection instruction requesting transmission of the software being executed as evidence data. The evidence collection instruction reception unit 106 receives the evidence collection instruction. Details of the evidence collection instruction will be described later.

Based on the evidence collection instruction received by the evidence collection instruction reception unit 106, the evidence data collection unit 107 collects evidence data. For example, software being executed is collected by being read from the memory 102. Details of the evidence data will be described later.

The evidence data transmission unit 108 transmits the collected evidence data to the verification device 200. When the verification device 200 is a server device installed outside the vehicle as illustrated in FIGS. 1B and 2, the individual ECU 50f, that is, the prover device 100, outputs evidence data to an in-vehicle network such as CAN, and transmits the evidence data from the external communication ECU 50b via the zone ECU 50 and the integrated ECU 50a. In contrast, when the verification device 200 is an ECU mounted on the vehicle as illustrated in FIG. 1C, the individual ECU 50f, that is, the prover device 100, outputs evidence data to an in-vehicle network such as CAN.

### (2) Configuration of Verification Device 200

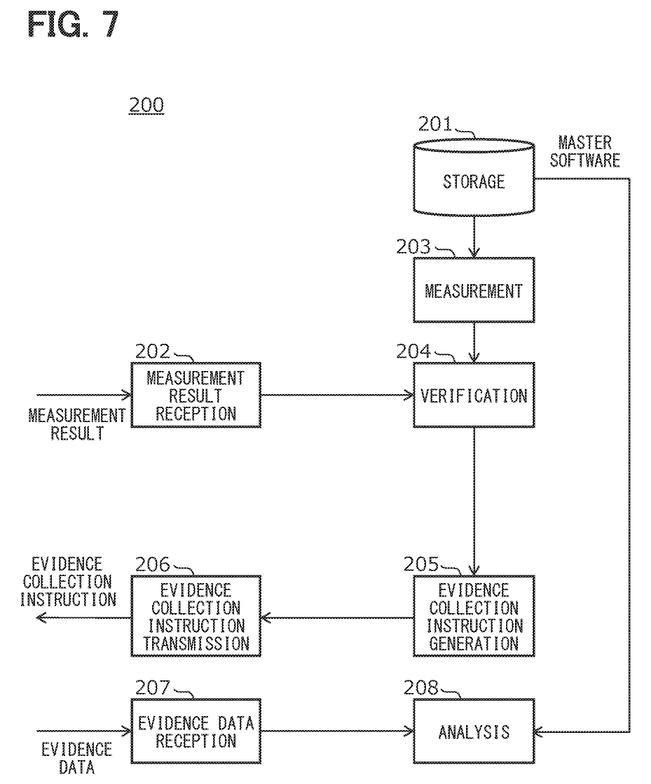

A configuration example of the verification device 200 according to the present embodiment will be described with reference to FIG. 7. The verification device 200 includes a storage unit 201, a measurement result reception unit 202, a measurement unit 203, a verification unit 204, an evidence collection instruction generation unit 205, an evidence collection instruction transmission unit 206, an evidence data reception unit 207, and an analysis unit 208.

In the storage unit 201, information regarding software stored or installed in the prover device 100 is stored in advance. Moreover, a copy of the software may be stored. This software is software that is executed in the prover device 100 and is a target of the measurement instruction. Hereinafter, the software stored in the storage unit 201 will be referred to as master software.

The storage unit 201 may be either an external storage device (hard disk, universal serial bus (USB) memory, compact disc (CD)/Blu-ray disc (BD), etc.) or an internal storage device (RAM, etc.). The device may be volatile or nonvolatile.

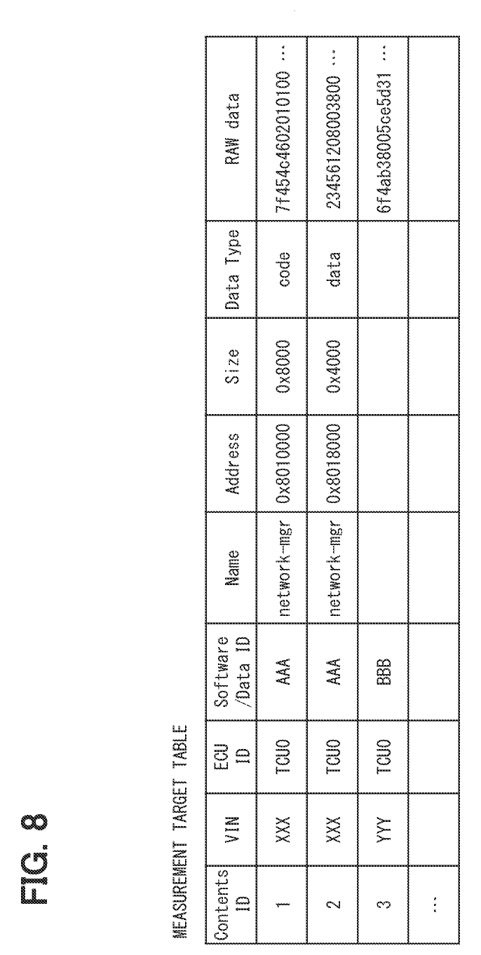

A specific example of the information stored in the storage unit 201 will be described with reference to FIG. 8.

The storage unit 201 stores a measurement target table that records information on software to be measured. As illustrated in FIG. 8, the measurement target table associates and stores a content identifier (Contents ID) that identifies software, a vehicle identifier (VIN) that identifies a vehicle on which the software is mounted, an identifier (ECU ID) of an ECU in which the software is installed, an identifier (Software/Data ID) that identifies a program or data included in the software, the name (Name) of the software, the start position (Address) of the software in memory, the size (Size) of the software, the data type (Data Type) of the software, and the software itself installed in the prover device 100, that is, raw data (RAW data) of the master software.

The measurement result reception unit 202 receives a measurement result from the prover device 100. For example, when the prover device 100 obtains hash values in FIG. 5 by calculation, these hash values h1, h2, h3 are the measurement results.

The measurement unit 203 executes measurement on the master software stored in the storage unit 201. In the present embodiment, a second hash value that is a hash value of the master software is calculated. The target for calculating the second hash value is specified based on the measurement target information included in the measurement result received by the measurement result reception unit 202. The calculation method for the second hash value is the same as that in FIG. 5.

The verification unit 204 verifies whether the first hash value, which is the measurement result received by the measurement result reception unit 202, matches the second hash value calculated by the measurement unit 203. When the values match, it can be confirmed that the software being executed in the prover device 100 has not been tampered with. When the values do not match, the possibility that the software being executed in the prover device 100 has been tampered with can be confirmed. In this case, the verification unit 204 outputs a verification result indicating the possibility that the software has been tampered with to the evidence collection instruction generation unit 205.

The evidence collection instruction generation unit 205 generates an evidence request instruction requesting necessary evidence data on the basis of the verification result based on the measurement result by the verification unit 204. For example, if the software is suspected of having been tampered with, all or a part of the software being executed in the prover device 100 is requested as evidence data to prove tampering or take measures against tampering.

For example, if the first hash values h1, h2, h3, which are the measurement results, all differ from the second hash value, there is a possibility that tampering has been carried out at least in the data1 region, and thus a part of software corresponding to data1 is requested as evidence. If only h3 of the first hash values differs from the second hash value, it is understood that no tampering has been carried out in the data1 and data3 regions, and thus a part of software corresponding to data2 is requested as evidence. In the former case, since there is a possibility that tampering has been carried out in the data3 and data2 regions, the data3 and data2 regions may also be requested as evidence, or the whole software may be requested as evidence.

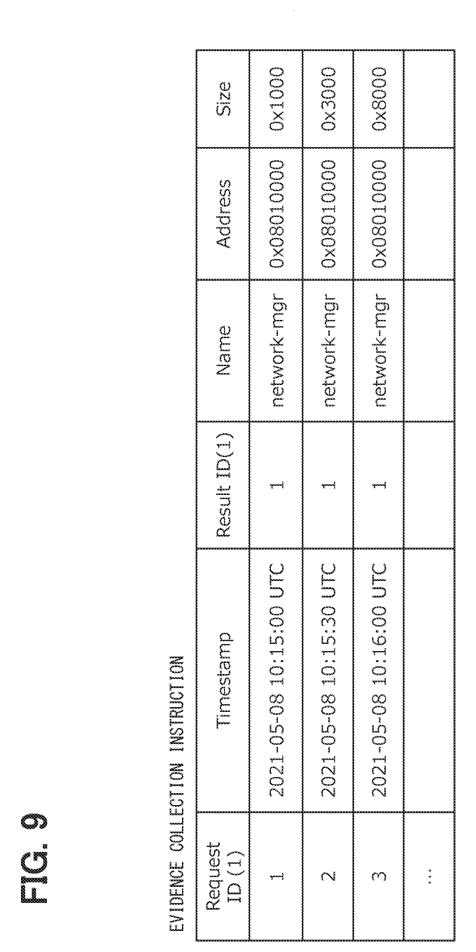

A specific example of the evidence collection instruction generated by the evidence collection instruction generation unit 205 will be described with reference to FIG. 9. In the example of FIG. 9, the evidence collection instruction includes the identifier (Request ID (1)) of the evidence collection instruction, a time (Timestamp) when the evidence collection instruction generation unit 205 generates the evidence collection instruction or when the evidence collection instruction transmission unit 206 transmits the evidence collection instruction, the identifier (Result ID (1)) of the measurement result that has caused the evidence collection instruction to be generated, the name (Name) of the software that is the evidence data to be requested, the start position (Address) of the software in the memory, and the size (Size) of the software.

In FIG. 9, the evidence collection instruction (Request ID (1): 1) in the first row is an example of requesting only data1 in FIG. 5 because the start position and the size of data1 are designated. The evidence collection instruction (Request ID (1): 2) in the second row is an example of requesting data1, data3, and data2 because the start position of data1 and the total size of data1, data3, and data2 are designated. The evidence collection instruction (Request ID (1): 3) on the third line is an example of requesting the entire software because the start position of data1 and the size of the entire target software are designated.

The evidence collection instruction transmission unit 206 transmits to the prover device 100, the evidence collection instruction generated by the evidence collection instruction generation unit 205.

The evidence data reception unit 207 receives evidence data from the prover device 100. The received evidence data is output to the analysis unit 208.

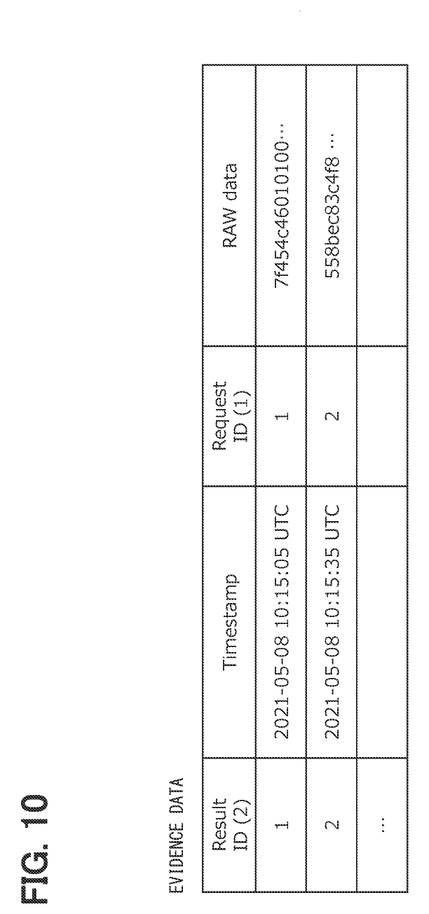

A specific example of the evidence data received by the evidence data reception unit 207 will be described with reference to FIG. 10. In the example of FIG. 10, the evidence data includes the identifier (Result ID (2)) of the evidence data, a time (Timestamp) when evidence data reception unit 207 receives the evidence data, the identifier (Request ID (1)) of the corresponding evidence collection instruction, and the raw data (RAW data) of the software that is the evidence data.

The analysis unit 208 analyzes the evidence data received by the evidence data reception unit 207. For example, the analysis unit 208 analyzes, based on the evidence data, whether the software has been tampered with, the specific content of the tampering, and a problem that may be caused if the software has been tampered with. Furthermore, an attack that has caused tampering may be identified, and a countermeasure against the attack may be performed, or the prover device 100 may be requested to collect additional evidence data.

### (3) Operation of Remote Attestation System 1

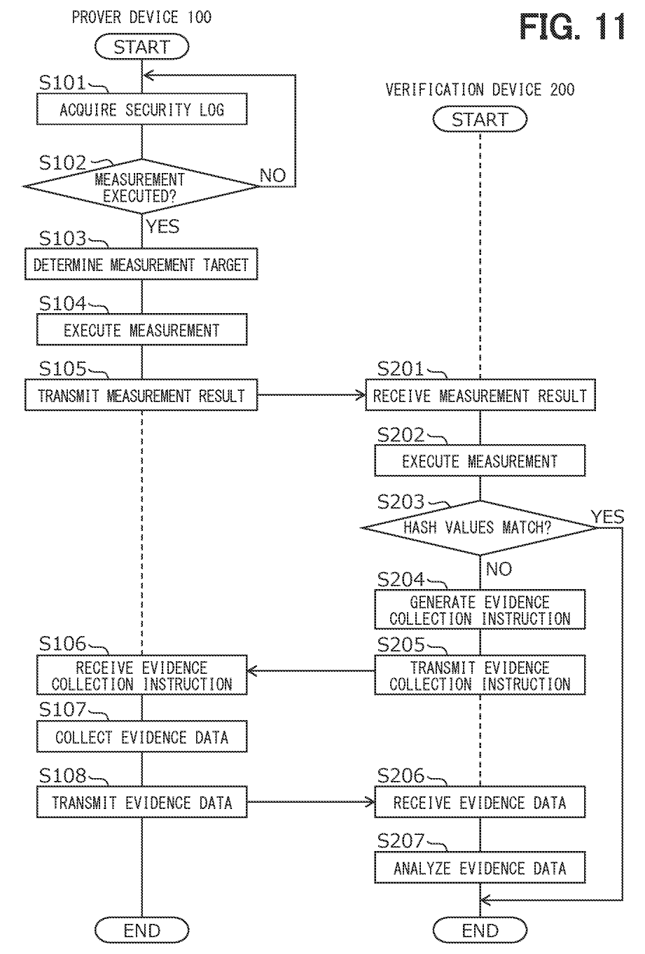

The operation of the remote attestation system 1, that is, the prover device 100 and the verification device 200, will be described with reference to a flowchart of FIG. 11. FIG. 11 illustrates not only attestation and verification methods performed in the prover device 100 and the verification device 200, respectively, but also processing procedures of attestation and verification programs that can be executed in the prover device 100 and the verification device 200, respectively. The processing to be described is not limited to the order indicated in FIG. 11. That is, the order may be interchanged unless there are restrictions, such as a relationship in which one step uses the result of its preceding step. The same applies to flowcharts of embodiments to be described later.

The log acquisition unit 103 of the prover device 100 acquires a security log generated by the security sensor (S101).

The measurement unit 104 determines whether to execute measurement based on the security log acquired in S101 (S102).

When determining to execute measurement (S102: Y), the measurement unit 104 determines a measurement target based on the security log acquired in S101 (S103).

The measurement unit 104 executes measurement on the measurement target determined in S103 (S104). In the present embodiment, the measurement unit 104 calculates the first hash value.

The measurement result transmission unit 105 transmits the result of the measurement executed in S104 to the verification device 200 (S105).

The measurement result reception unit 202 of the verification device 200 receives the measurement result transmitted from the prover device 100 (S201).

Based on the measurement target information included in the measurement result received in S201, the measurement unit 203 reads the software measurement target from the software storage unit 101 into the memory 102, and executes measurement (S202).

The verification unit 204 verifies whether the first hash value included in the measurement result received in S201 matches the second hash value calculated in S202 (S203).

As a result of the verification by the verification unit 204, when the first hash value and the second hash value differ (S203: N), the evidence collection instruction generation unit 205 generates an evidence collection instruction (S204).

The evidence collection instruction transmission unit 206 transmits the evidence collection instruction generated in S204 to the prover device 100 (S205).

The evidence collection instruction reception unit 106 of the prover device 100 receives the evidence collection instruction transmitted from the verification device 200 (S106).

The evidence data collection unit 107 collects evidence data based on the evidence collection instruction received in S106 (S107).

The evidence data transmission unit 108 transmits the evidence data collected in S107 to the verification device 200 (S108).

The evidence data reception unit 207 of the verification device 200 receives the evidence data transmitted in S108 (S206).

The analysis unit 208 analyzes the evidence data received in S206 (S207).

### (4) Summary

As described above, according to the prover device 100 of the present embodiment, remote attestation measurement is executed, triggered by the acquisition of the security log as a trigger for executing measurement. Therefore, when the software is tampered with, from the time of tampering until remote attestation measurement is executed, it is possible to prevent evidence of the attack from being altered by the attacker, or to prevent the software from being reset due to power-off of the vehicle or the like and the tampered data from being lost.

### 3. Second Embodiment

In the first embodiment, a configuration has been described in which measurement is executed, triggered by the prover device acquiring the security log and the measurement result is transmitted to the verification device. In the present embodiment, a configuration will be described in which, triggered by the acquisition of a security log, a measurement target is stored in a storage unit provided in a secure area, and measurement is executed.

### (1) Configuration of Prover Device 110

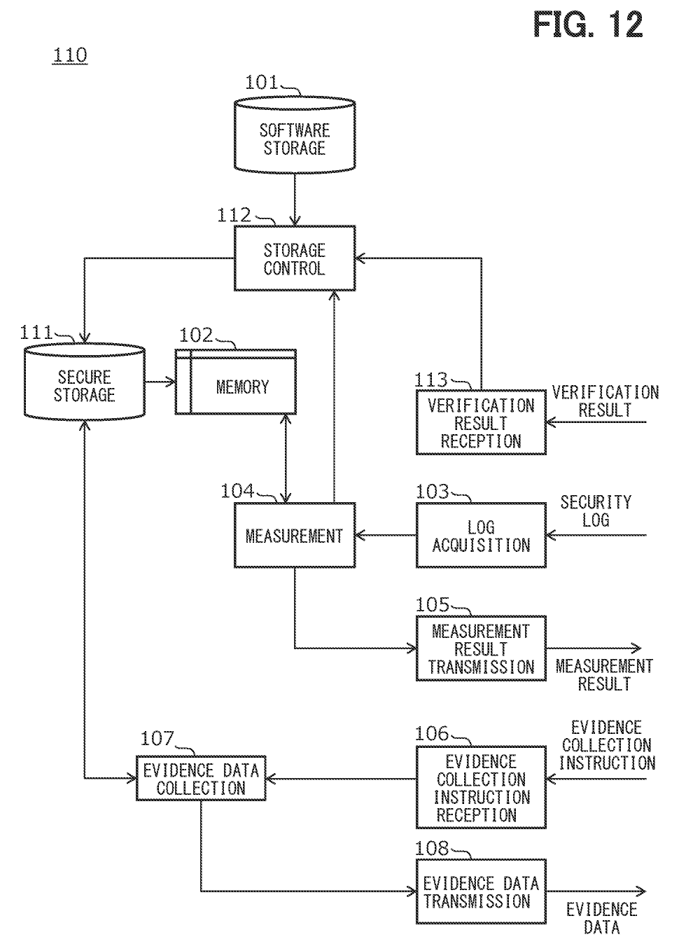

A configuration example of the prover device 110 according to a second embodiment will be described with reference to FIG. 12. Detailed description of the same configuration as that of the prover device according to the first embodiment will be omitted by referring to the description of FIG. 4, and differences from the first embodiment will be mainly described.

The prover device 110 according to the present embodiment includes a secure storage unit 111, a storage control unit 112, and a verification result reception unit 113 in addition to each configuration of the prover device 100 according to the first embodiment.

The secure storage unit 111 is a memory provided in a secure area. The secure storage unit 111 may be either an external storage device (hard disk, universal serial bus (USB) memory, compact disc (CD)/Blu-ray disc (BD), etc.) or an internal storage device (RAM, etc.). The device may be volatile or nonvolatile. However, when the ECU that is frequently powered off is the prover device, the secure storage unit 111 is desirably nonvolatile in order to prevent information stored in the secure storage unit 111 from being lost. In FIG. 12, the secure storage unit 111 is illustrated as a block different from the software storage unit 101 and the memory 102, but a region serving as the secure storage unit 111 may be provided in the software storage unit 101 or the memory 102.

The storage control unit 112 controls storage of data in and deletion of data from the secure storage unit 111. Triggered by the log acquisition unit 103 acquiring the security log, the storage control unit 112 stores, in the secure storage unit 111, the raw data of the measurement target determined by the measurement unit 104 from the software stored in the software storage unit 101.

In the first embodiment, the prover device 100 has read the software stored in the software storage unit 101 into the memory 102 to place the software in the memory and execute the software. In contrast, in the present embodiment, the software stored in the secure storage unit 111 is read into the memory 102 to place the software in the memory and execute the software. That is, the measurement unit 104 executes measurement on the measurement target of the software stored in the secure storage unit 111.

The measurement result transmission unit 105 transmits the measurement result to the verification device 210 “immediately” after the measurement unit 104 executes measurement.

Here, “immediately” also includes a case where the transmission is performed after preparation necessary for transmitting the measurement result has been performed.

Upon receiving the evidence collection instruction, the evidence data collection unit 107 of the present embodiment collects the measurement target stored in the secure storage unit 111 as evidence data, and the evidence data transmission unit 108 transmits the evidence data to the verification device 210.

After the measurement target is transmitted as evidence data to the verification device 210, the storage control unit 112 deletes the measurement target stored in the secure storage unit 111.

Even if the measurement target has not been transmitted as evidence data, the storage control unit 112 may delete the measurement target stored in the secure storage unit 111 when a predetermined condition is satisfied. In the present embodiment, when the verification result reception unit 113 receives a verification result indicating that hash values match as a result of verifying the hash values by the verification device 210, the storage control unit 112 deletes the measurement target stored in the secure storage unit 111. Alternatively, the storage control unit 112 may delete the measurement target stored in the secure storage unit 111 when a predetermined period has elapsed after the measurement target is stored in the secure storage unit 111.

The verification result reception unit 113 receives from the verification device 210, the verification result indicating that the hash values are the same as a result of verifying the hash values by the verification device 210.

### (2) Configuration of Verification Device 210

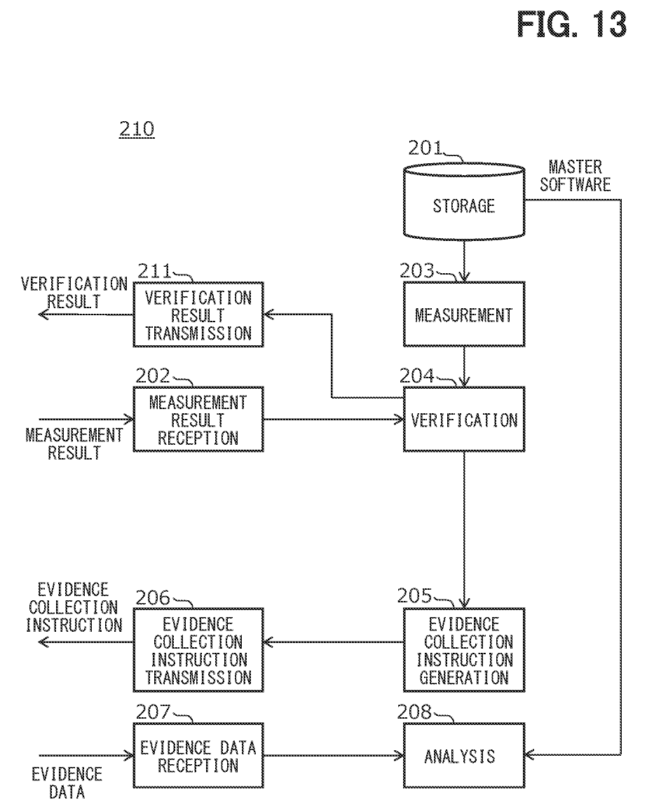

A configuration example of the verification device 210 according to the second embodiment will be described with reference to FIG. 13. Detailed description of the same configuration as that of the verification device 200 according to the first embodiment will be omitted by referring to the description of FIG. 7, and differences from the first embodiment will be mainly described.

The verification device 210 according to the present embodiment includes a verification result transmission unit 211 in addition to each configuration of the verification device 200 according to the first embodiment.

When the first hash value and the second hash value match, the verification unit 204 of the present embodiment outputs a verification result indicating that the hash values match to the verification result transmission unit 211.

The verification result transmission unit 211 transmits the verification result indicating that the hash values match to the prover device 110.

### (3) Configuration of Remote Attestation System 1

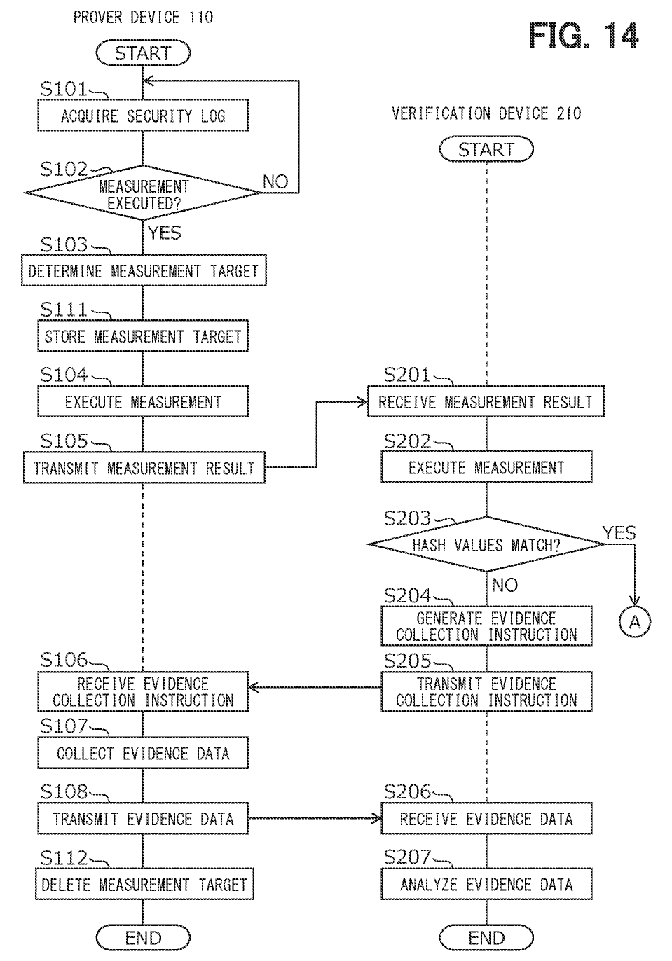

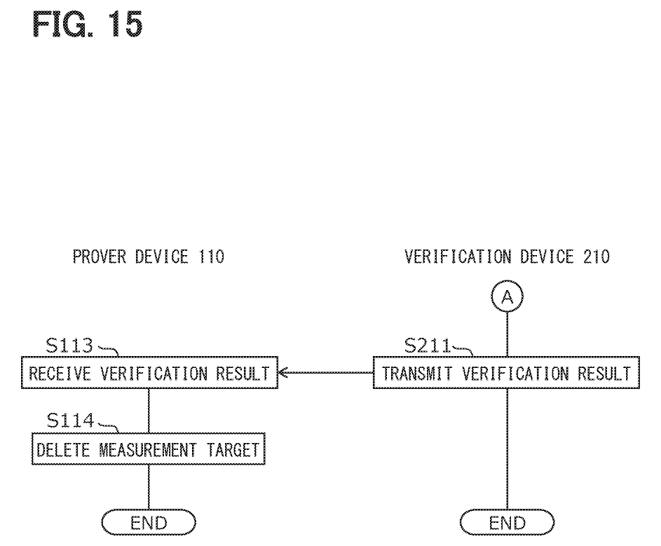

The operation of the remote attestation system 1 according to the present embodiment will be described with reference to FIGS. 14 and 15. The same processing as that in the first embodiment will be described with reference to FIG. 11, and detailed description thereof will be omitted.

When the measurement unit 104 of the prover device 110 determines a measurement target (S103), the storage control unit 112 stores the measurement target determined in S103 in the secure storage unit 111 (S111).

The measurement unit 104 executes measurement on the measurement target stored in the secure storage unit 111 in S111 (S104).

When the evidence data transmission unit 108 transmits the evidence data to the verification device 210 (S108), the storage control unit 112 deletes the measurement target stored in the secure storage unit 111 from the secure storage unit 111 (S112).

FIG. 15 illustrates processing when the hash values match as a result of the verification in the verification device 210 (S203: Y).

The verification result transmission unit 211 of the verification device 210 transmits a verification result indicating that the hash values match to the prover device 110 (S211).

The verification result reception unit 113 of the prover device 110 receives the verification result transmitted in S211 (S113).

The storage control unit 112 deletes the measurement target stored in the secure storage unit 111 (S114).

### (4) Summary

According to the present embodiment, triggered by the acquisition of the security log, the measurement target is stored in the secure storage unit 111, and measurement is executed. As a result, it is possible to prevent the measurement target from being tampered from the time measurement is executed until the measurement target is transmitted to the verification device 210 as evidence data, and thus, it is possible to reliably transmit the measurement target subjected to the measurement to the verification device 210 as evidence data.

### 4. Third Embodiment

In the second embodiment, a configuration has been described in which, triggered by the prover device acquiring the security log, the measurement target is stored in the secure storage unit to execute measurement, and the measurement result is immediately transmitted to the verification device. In the present embodiment, a configuration will be described in which, triggered by the acquisition of the security log, the measurement target is stored in the secure storage unit to execute measurement as in the second embodiment, but the measurement result is transmitted to the verification device upon receiving an instruction from the verification device.

### (1) Configuration of Prover Device 120

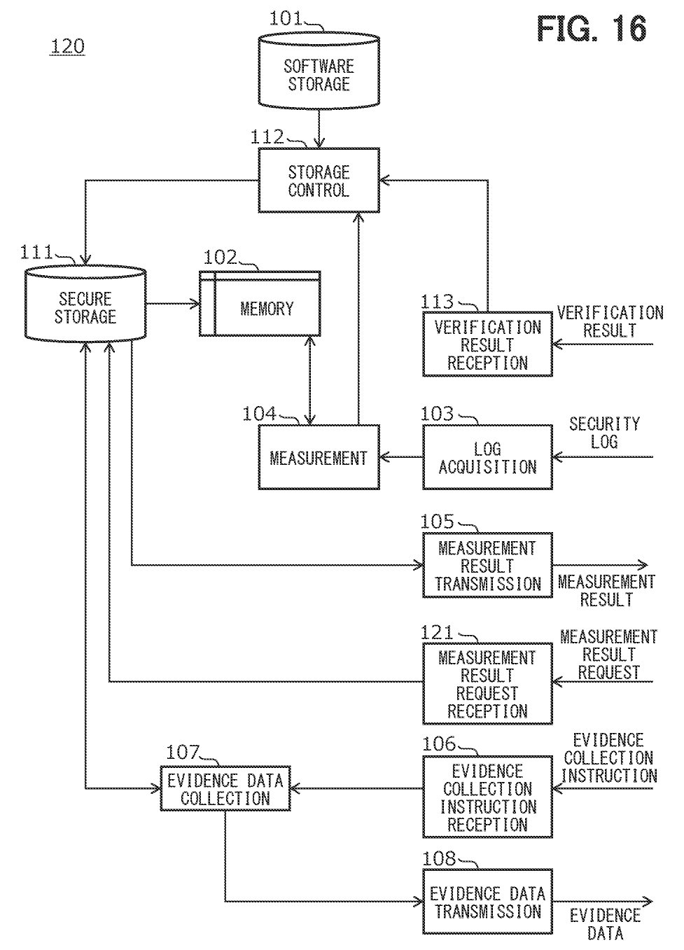

A configuration example of the prover device 120 according to the third embodiment will be described with reference to FIG. 16. Detailed description of the same configurations as those of the prover devices according to the first and second embodiments will be omitted by referring to the description of FIGS. 4 and 12, and differences from the first and second embodiments will be mainly described.

The prover device 120 according to the present embodiment includes a measurement result request reception unit 121 in addition to each configuration of the prover device 110 according to the second embodiment.

The measurement result request reception unit 121 receives a measurement result request generated by the verification device 220 to be described later from the verification device 220. The measurement result request requests the transmission of the result of the measurement executed in the prover device 120 to the verification device 220.

The storage control unit 112 of the present embodiment stores the result of the measurement by the measurement unit 104 in the secure storage unit 111 in addition to the measurement target.

In the second embodiment, the measurement result transmission unit 105 transmits the measurement result to the verification device 210 immediately after execution of the measurement by the measurement unit 104. In contrast, in the present embodiment, when the measurement result request reception unit 121 receives a measurement result request, the measurement result transmission unit 105 transmits the measurement result stored in the secure storage unit 111 to the verification device 220 based on the measurement result request. The measurement result transmitted by the measurement result transmission unit 105 is a measurement result corresponding to the measurement target designated by the measurement result request. When the measurement result of the measurement target designated by the measurement result request is not stored in the secure storage unit 111, information indicating that a measurement result of the target does not exist may be transmitted to the verification device 220.

After the transmission of the measurement target as evidence data to the verification device 220, the storage control unit 112 of the present embodiment deletes the measurement result in addition to the measurement target stored in the secure storage unit 111. Alternatively, the storage control unit 112 may delete the measurement result stored in the secure storage unit 111 after transmitting the measurement result to the verification device 220.

### (2) Configuration of Verification Device 220

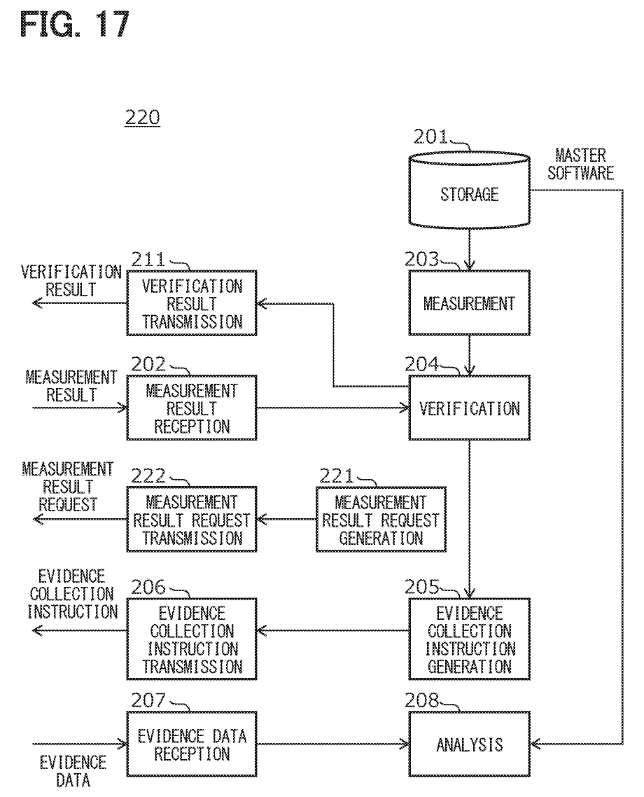

A configuration example of the verification device 220 according to the third embodiment will be described with reference to FIG. 17. Detailed description of the same configurations as those of the verification devices according to the first and second embodiments will be omitted by referring to the description of FIG. 7 and FIG. 13, and differences from the first and second embodiments will be mainly described.

The verification device 220 according to the present embodiment includes a measurement result request generation unit 221 and a measurement result request transmission unit 222 in addition to each configuration of the verification device 210 according to the second embodiment.

The measurement result request generation unit 221 generates a measurement result request requesting the prover device 120 to transmit a measurement result. The timing at which the measurement result request generation unit 221 generates a measurement result request is arbitrary. For example, when a vehicle of the same model as the vehicle on which the prover device 120 is mounted is subjected to a cyberattack, there is a possibility that the vehicle on which the prover device 120 is mounted has also been subjected to the same cyberattack. In such a case, the verification device 220 generates a measurement result request for the prover device 120. The measurement result request may be a request for specifying a measurement target and requesting a measurement result, or may be a request for all measurement results of the prover device 120.

The measurement result request transmission unit 222 transmits the measurement result request generated by the measurement result request generation unit 221 to the prover device 120.

### (3) Operation of Remote Attestation System 1

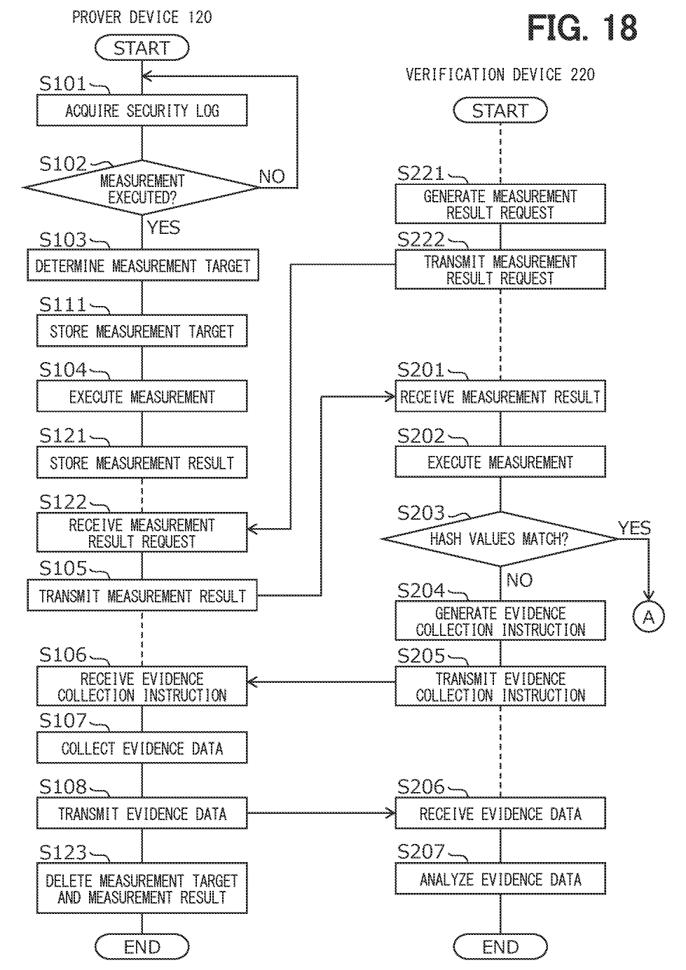

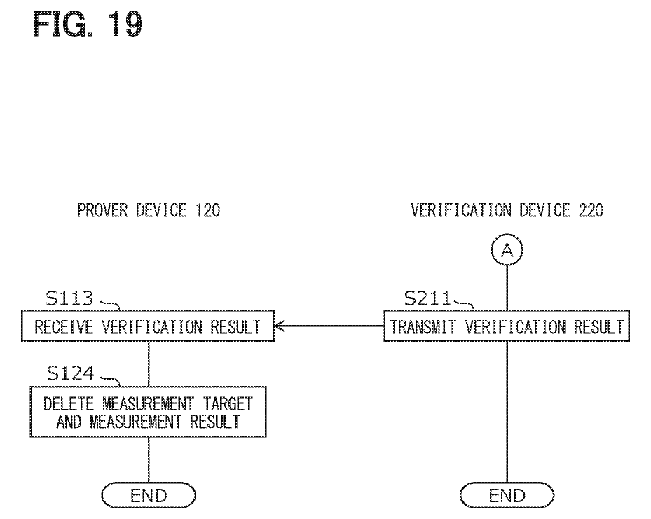

The operation of the remote attestation system 1 according to the present embodiment will be described with reference to FIGS. 18 and 19. The same processes as those in the first and second embodiments will be described with reference to FIGS. 11, 14, and 15, and detailed description thereof is omitted.

The measurement result request generation unit 221 of the verification device 220 generates a measurement result request (S221).

The measurement result request transmission unit 222 transmits the measurement result request generated in S221 to the prover device 120 (S222).

The storage control unit 112 of the prover device 120 stores the measurement result of the measurement executed in S104 in the secure storage unit 111 (S121).

When the measurement result request reception unit 121 receives the measurement result request transmitted from the verification device 220 in S222 (S122), the measurement result transmission unit 105 transmits the measurement result stored in the secure storage unit 111 to the verification device 220 based on the measurement result request (S105).

When the evidence data transmission unit 108 transmits the evidence data to the verification device 210 (S108), the storage control unit 112 deletes the measurement result from the secure storage unit 111 in addition to the measurement target stored in the secure storage unit 111 (S123).

FIG. 19 illustrates processing when the hash values match as a result of the verification in the verification device 220.

The verification result reception unit 113 of the prover device 110 receives the verification result transmitted in S211 (S113).

The storage control unit 112 deletes the measurement result in addition to the measurement target stored in the secure storage unit 111 (S124).

### (4) Summary

According to the present embodiment, the prover device 120 transmits a measurement result to the verification device 220 only when there is a request from the verification device 220, so that the communication load applied to transmission of the measurement result can be reduced.

### 5. Fourth Embodiment

In each of the first to third embodiments, a configuration has been described in which measurement is executed, triggered by the prover device acquiring the security log. In the present embodiment, a configuration will be described in which the verification device instructs the prover device to execute measurement triggered by the acquisition of the security log, and the prover device executes measurement based on the measurement instruction from the verification device.

### (1) Configuration of Prover Device 130

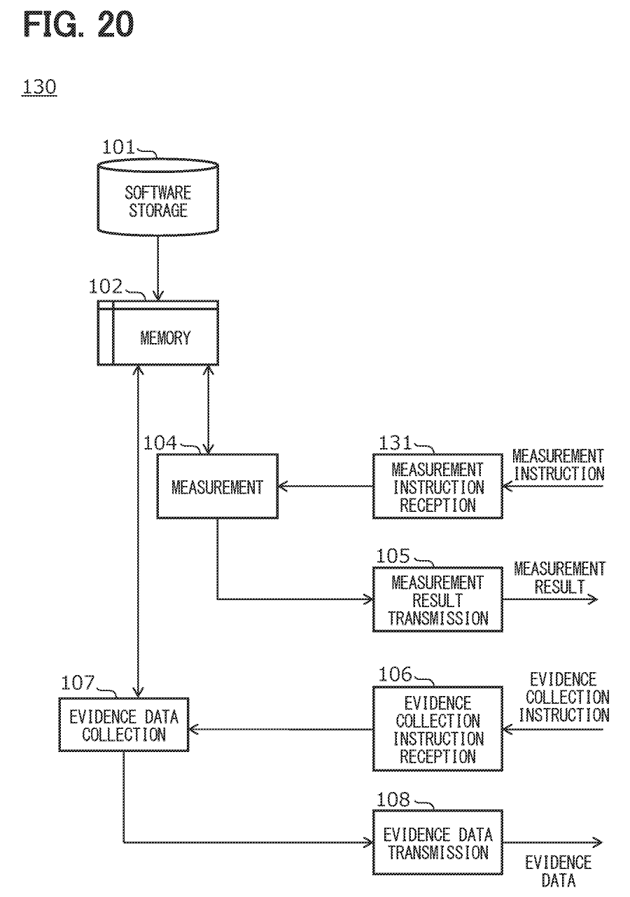

A configuration example of the prover device 130 according to a fourth embodiment will be described with reference to FIG. 20. Detailed description of the same configuration as that of the prover device according to the first embodiment will be omitted by referring to the description of FIG. 4, and differences from the first embodiment will be mainly described.

Unlike the first to third embodiments, the prover device 130 according to the present embodiment does not include the log acquisition unit 103. Instead, the prover device 130 includes a measurement instruction reception unit 131.

The measurement instruction reception unit 131 receives the measurement instruction generated by the verification device 230 from the verification device 230. The measurement instruction includes measurement target information indicating a measurement target in software and a nonce. The measurement target information only needs to be information that can specify all or a part of the software in the memory, and examples thereof include an address and a size.

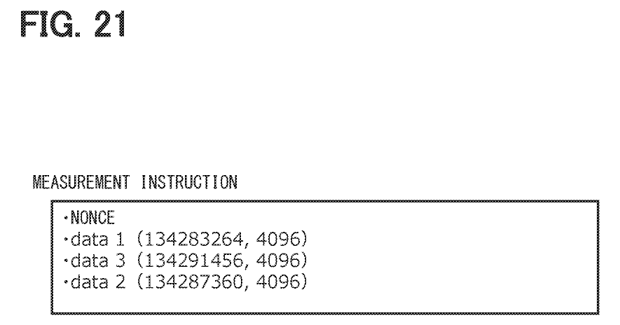

A specific example of the measurement instruction received by the measurement instruction reception unit 131 will be described with reference to FIG. 21. In the case of FIG. 21, the received measurement instruction includes three regions as the measurement target information in addition to the nonce. The first region is indicated by data1, with a start address of 134283264 (decimal notation), and a size of 4096 bytes. The second region is indicated by data3, with a start address of 134291456 (decimal notation), and a size of 4096 bytes. A third region is indicated by data2, with a start address of 134287360 (decimal notation), and a size of 4096 bytes.

This measurement instruction also includes an instruction to execute measurement in the order of data1, data3, and data2. That is, the order of data1, data3, and data2 corresponds to measurement order information.

The nonce is, for example, a random number generated by the verification device 230, but may also be any numerical value with low predictability, even if not completely random.

The measurement unit 104 of the present embodiment executes measurement triggered by the measurement instruction reception unit 131 receiving the measurement instruction. Here, in each of the first to third embodiments, the measurement unit 104 has calculated the hash value h1 using data1 as described with reference to FIG. 5. In the present embodiment, since the measurement instruction includes the nonce, the hash value h1 is calculated by executing measurement using the nonce for data1 to be measured. That is, as the hash value h1, the measurement unit 104 calculates h1 = f(Nonce, data1), where f is a hash function.

By calculating the hash value using the nonce transmitted from the verification device 230, the prover device 130 can calculate a different hash value for each measurement, thereby preventing a replay attack.

### (2) Configuration of Verification Device 230

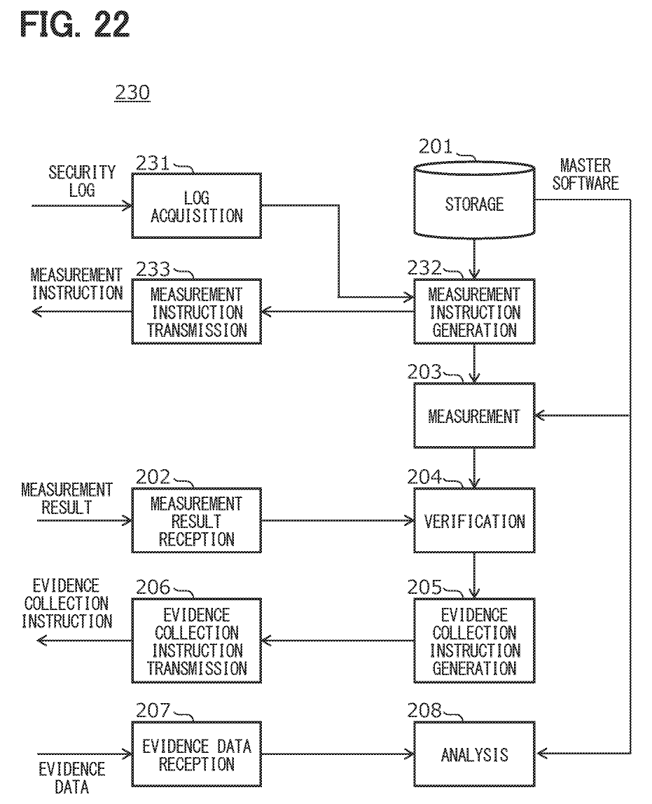

A configuration example of the verification device 230 according to the fourth embodiment will be described with reference to FIG. 22. Detailed description of the same configuration as that of the verification device according to the first embodiment will be omitted by referring to the description of FIG. 7, and differences from the first embodiment will be mainly described.

A log acquisition unit 231 acquires a security log generated by a security sensor mounted on the ECU 50. As illustrated in FIG. 2, since the prover device 130 according to the present embodiment is the external communication ECU 50b, the log acquisition unit 231 of the verification device 230 acquires the security log via the prover device 130. However, the log acquisition unit 231 may directly acquire the security log from the ECU 50.

A measurement instruction generation unit 232 generates a measurement instruction for the prover device 130 triggered by the log acquisition unit 231 acquiring the security log. The measurement instruction instructs calculation of a hash value that is a measurement value of software executed in the prover device 130. The measurement instruction includes measurement target information indicating a measurement target in software. For example, as in the example of FIG. 21, the measurement instruction includes a nonce and a plurality of pieces of measurement target information (data1, data3, data2), and also includes measurement order information (data1, data3, data2) indicating an order in which the plurality of pieces of measurement target information are to be processed.

Similarly to the measurement unit 104 of the first embodiment and the like, the measurement instruction generation unit 232 may determine, based on the content of the security log, whether to execute measurement and/or determine the measurement target.

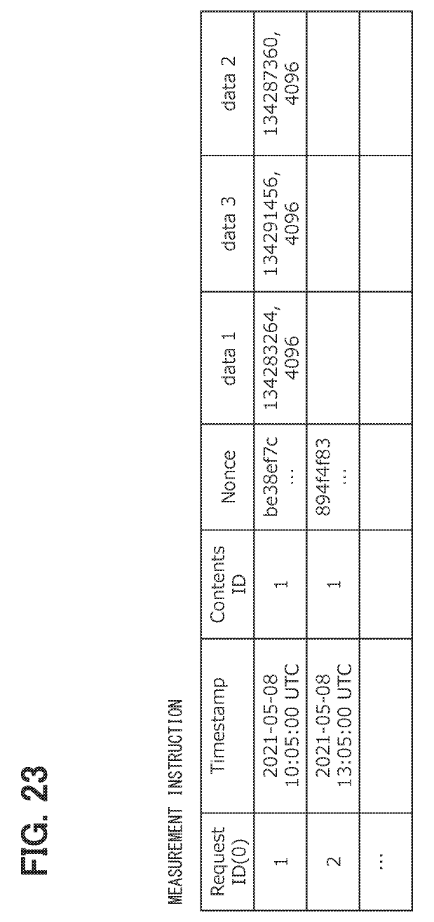

A specific example of the measurement instruction generated by the measurement instruction generation unit 232 will be described with reference to FIG. 23. In the example of FIG. 23, the measurement instruction includes the identifier (Request ID(0)) of the measurement instruction, a time (Timestamp) when the measurement instruction generation unit 232 generates the measurement instruction or when a measurement instruction transmission unit 233 transmits the measurement instruction, a content identifier (Contents ID) that identifies software being executed in the prover device 130, a nonce (Nonce), and measurement target information (data1, data3, data2). When the calculation of the hash value for the entire software is instructed, the measurement target information is unnecessary if the placement of the software is known.

In addition, a vehicle identifier (VIN) that identifies a vehicle, an identifier (ECU ID) of an ECU in which software is installed, and an identifier (Software/Data ID) that identifies a program or data included in executed software may be included.

The measurement instruction transmission unit 233 transmits the measurement instruction generated by the measurement instruction generation unit 232 to the prover device 130.

### (3) Operation of Remote Attestation System 1

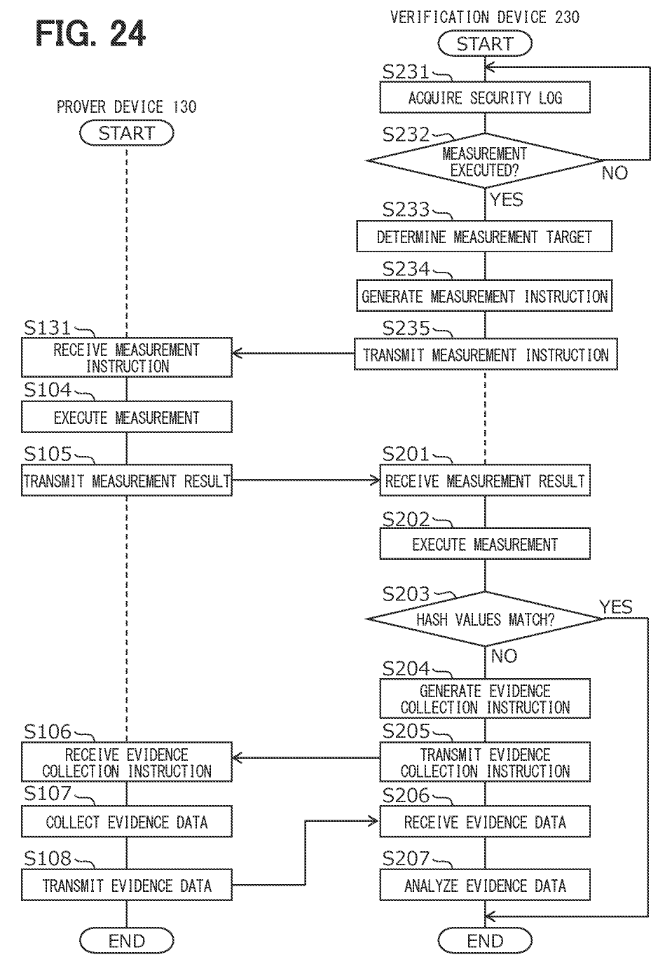

The operation of the remote attestation system 1 according to the present embodiment will be described with reference to FIG. 24. The same processing as that in the first embodiment will be described with reference to FIG. 11, and detailed description thereof will be omitted.

The log acquisition unit 231 of the verification device 230 acquires the security log generated by the security sensor (S231).

The measurement instruction generation unit 232 determines whether to execute measurement based on the security log acquired in S231 (S232).

When determining to execute measurement (S232: Y), the measurement instruction generation unit 232 determines the measurement target based on the security log acquired in S231 (S233).

The measurement instruction generation unit 232 generates a measurement instruction including measurement target information indicating the measurement target determined in S233 and a nonce (S234).

The measurement instruction transmission unit 233 transmits the measurement instruction generated in S234 to the prover device 130 (S235).

The measurement instruction reception unit 131 of the prover device 130 receives the measurement instruction transmitted in S235 (S131).

The measurement unit 104 executes measurement based on the measurement instruction received in S235 (S104).

### (4) Summary

In the present embodiment, by executing measurement based on the measurement instruction including the nonce, the prover device can generate a different measurement result for each measurement and can thus prevent a replay attack.

### 6. Modification

In any of the embodiments described above, a configuration has been described in which the measurement unit 104 of the prover device 100 or the like executes measurement using detection of a security event by the security sensor as a trigger. In the present modification, a configuration will be described in which, triggered by the acquisition of the security log, the prover device executes only a process of storing the measurement target in a storage unit provided in a secure area, and measurement is executed based on a measurement instruction from the verification device.

### (1) Configuration of Prover Device 140

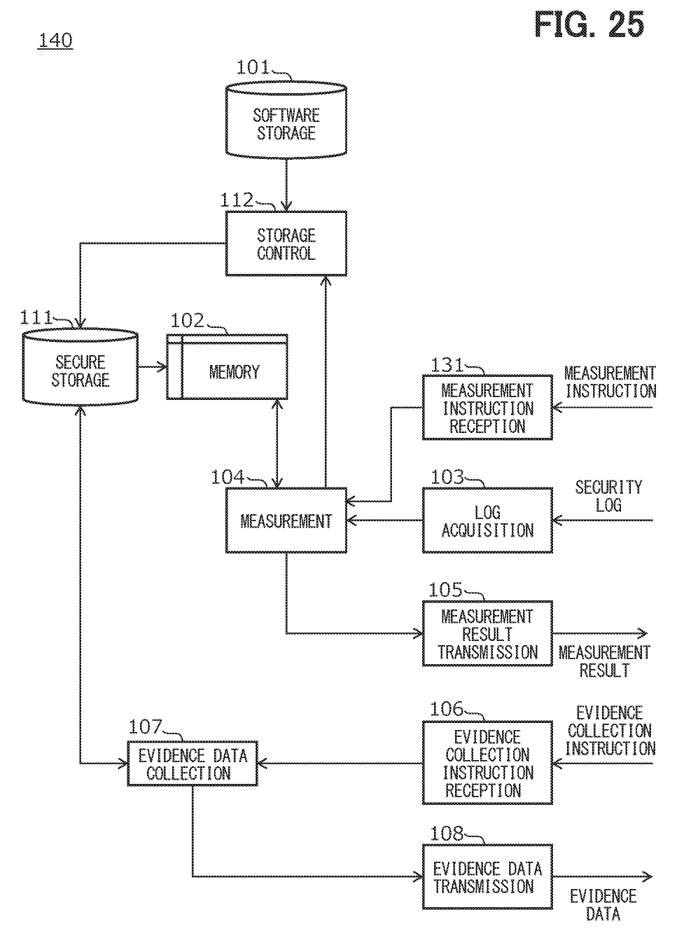

A configuration example of the prover device 140 according to the present modification will be described with reference to FIG. 25. The prover device 140 includes the secure storage unit 111 and the storage control unit 112 in the second and third embodiments, and the measurement instruction reception unit 131 in the fourth embodiment.

Triggered by the log acquisition unit 103 acquiring the security log, the storage control unit 112 of the present modification stores the measurement target determined by the measurement unit 104 in the secure storage unit 111.

Triggered by the measurement instruction reception unit 131 receiving the measurement instruction from the verification device 240, the measurement unit 104 executes measurement on the measurement target stored in the secure storage unit 111. That is, unlike the first to third embodiments, the measurement unit 104 of the present modification does not execute measurement triggered by the acquisition of the security log.

### (2) Configuration of Verification Device 240

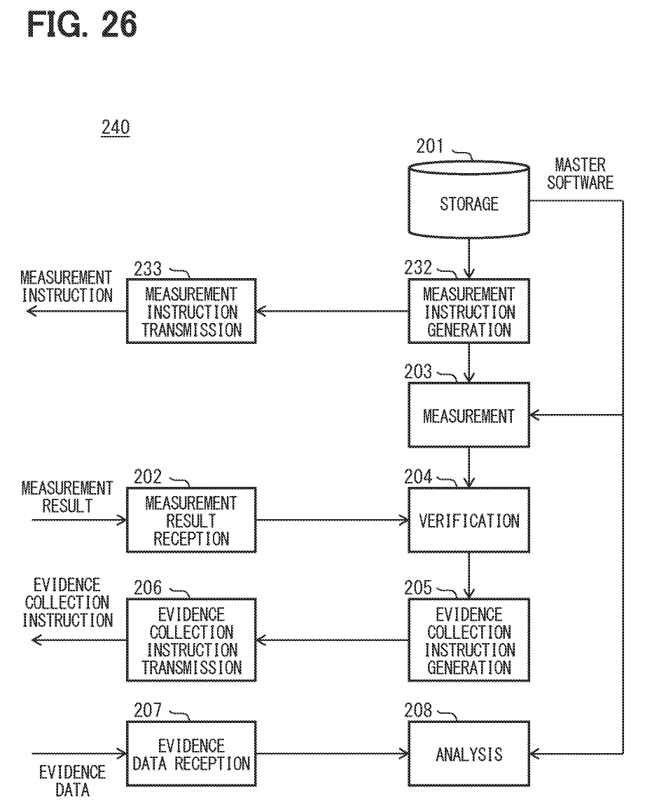

A configuration example of the verification device 240 according to the present modification will be described with reference to FIG. 26. The verification device 240 includes the measurement instruction generation unit 232 and the measurement instruction transmission unit 233 as in the fourth embodiment, but does not include the log acquisition unit 231 unlike the verification device 230.

The measurement instruction generation unit 232 of the present modification generates a measurement instruction at any timing. For example, the measurement instruction generation unit 232 periodically generates a measurement instruction at regular intervals. That is, unlike the fourth embodiment, the present modification does not generate a measurement instruction triggered by the verification device 240 acquiring the security log.

### (3) Configuration of Remote Attestation System 1

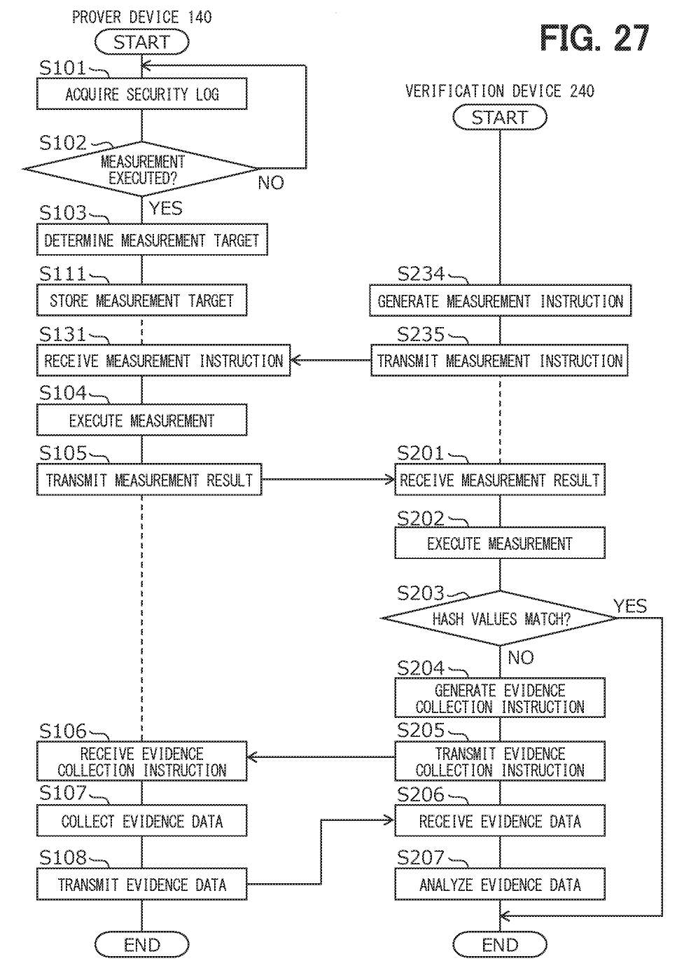

The operation of the remote attestation system 1 according to the present modification will be described with reference to FIG. 27. The same processing as those in the first to fourth embodiments will be described with reference to the description of each embodiment, and detailed description thereof will be omitted.

In the present modification, similarly to the second and third embodiments, the measurement target determined in S103 is stored in the secure storage unit 111 (S111). However, unlike the second and third embodiments, measurement is not immediately executed after the execution of the process of S111.

As in the fourth embodiment, when the measurement instruction is generated by the measurement instruction generation unit 232 of the verification device 240 (S234) and the measurement instruction is transmitted from the measurement instruction transmission unit 233 (S235), the measurement instruction reception unit 131 of the prover device 140 receives the measurement instruction (S131).

The measurement unit 104 measures the measurement target, stored in the secure storage unit 111, based on the measurement instruction received in S131 (S104).

### 7. General remarks

The features of the prover device, the remote attestation system, and the certification method and the certification program executed in the prover device according to each embodiment have been described above.

Since the term used in each embodiment is an example, it may be replaced with a synonymous term or a term including a synonymous function.

The block diagram used for the description of each embodiment is obtained by classifying and arranging the configuration of the device by function. The block showing each function is implemented by any combination of hardware and software. In addition, since the functions are shown, the block diagram can be understood as a disclosure of a method and a disclosure of a program to implement the method.

The order of the functional blocks that can be understood as the processing, the flow, and the method described in each embodiment may be changed unless there are restrictions, such as a relationship in which one step uses the result of another step in the preceding step.

The terms first, second, or N (N is an integer) used in each embodiment and the present disclosure are used to distinguish between two or more configurations or methods of the same type and do not limit the order or superiority.

The following are examples of the forms of devices according to the present disclosure.

Examples of the form of the component include a semiconductor element, an electronic circuit, a module, and a microcomputer.

Examples of the form of the semi-finished product include an electronic control device (electric control unit, ECU) and a system board.

Examples of the form of the finished product include a mobile phone, a smartphone, a tablet, a personal computer (PC), a workstation, and a server.

In addition, devices with communication functions, and the like are included, and examples thereof include a video camera, a still camera, and a car navigation system.

To each device, necessary functions such as an antenna and a communication interface may be added.

In addition, the present disclosure can be implemented not only with dedicated hardware configured and functioning as described in each embodiment, but also through a combination of a program, recorded in a recording medium such as memory or a hard disk, for realizing the present disclosure with general-purpose hardware, including a dedicated or general-purpose CPU, memory, and the like, capable of executing the program.

The program stored in a non-transitory tangible recording medium (e.g., an external storage device (hard disk, USB memory, CD/BD, etc.) or an internal storage device (RAM, ROM, etc.)) of dedicated or general-purpose hardware can also be provided to dedicated or general-purpose hardware via a recording medium, or from a server via a communication line without a recording medium. As a result, it is possible to always provide the latest functions through program upgrade.

The present disclosure has mainly described the case where an in-vehicle electronic control device mounted on an automobile is used as a prover device. However, the present disclosure can be applied to all mobile bodies such as motorcycles, ships, trains, and aircraft. The present disclosure is applicable not only to mobile bodies but also to all products including microcomputers.

In the present disclosure, the term “processor” refers to a processor as a single piece or a plurality of pieces of hardware, and is configured to read a computer program code included in the computer program (i.e., one or more commands of the computer program) each time to execute processing defined by the computer program code. In other words, the “processor” is a hardware device that executes one or more programmed processes. Therefore, the computer program code can also be referred to as software capable of defining the processing of the processor in accordance with the content thereof. The “processor” is a general purpose or specific purpose processor, and may be, for example, a CPU, a microprocessor, a graphics processing unit (GPU), a data flow processor (DFP), or the like, but is not limited thereto.

In the present disclosure, the term “circuit” refers to a logic circuit as a single piece or a plurality of pieces of hardware, and is configured to execute specific processing defined based on a pre-designed circuit configuration. In other words, (and in contrast to “processor”), the “circuit” in the present disclosure refers to a hardware device that executes specific processing based on a circuit configuration, rather than processing defined by software such as the above-mentioned computer program code. For example, the “circuit” may include a custom integrated circuit (IC), such as an application-specific integrated circuit (ASIC) or a field-programmable gate array (FPGA), designed using a hardware description language (HDL). That is, the “circuit” in the present disclosure includes all hardware circuits except for the above-mentioned processor that executes processing by reading computer program code.

In the present disclosure, the expression “at least one of the circuit or the processor” should be interpreted in the disjunctive sense (logical sum), and not as at least one circuit and at least one processor. Therefore, in the present disclosure, “at least one of the circuit or the processor causes the prover device to perform a function” includes a case where only the circuit causes the prover device to perform all functions. In addition, “at least one of the circuit or the processor causes the prover device to perform a function” includes a case where only the processor causes the prover device to perform all functions. Moreover, “at least one of the circuit or the processor causes the prover device to perform a function” includes a case where the circuit causes the prover device to perform some functions, and the processor causes the prover device to perform the remaining functions. In the last example, for example, when the prover device is to perform functions A to C, functions A and B may be implemented by the circuit, and the remaining function C may be implemented by the processor.

(Examples of the technical concepts disclosed herein)

### (Item 1)

A prover device in a remote attestation system including a prover device and a verification device includes:
a measurement unit configured to execute measurement using detection of a security event by a security sensor as a trigger;
a measurement result transmission unit configured to transmit a measurement result by the measurement unit to the verification device;
an evidence collection instruction reception unit configured to receive an evidence collection instruction requesting evidence data from the verification device receiving the measurement result; and
an evidence data transmission unit configured to transmit the evidence data to the verification device based on the evidence collection instruction.

### (Item 2)

The prover device according to item 1 further includes

a log acquisition unit configured to acquire a security log indicating occurrence of the security event from the security sensor.

The measurement unit executes the measurement triggered by the log acquisition unit acquiring the security log as the trigger.

### (Item 3)

In the prover device according to item 2,

the measurement unit determines a measurement target, which is a target for executing the measurement, based on content of the security log.

### (Item 4)

In the prover device according to item 2,

the measurement unit determines whether to execute the measurement based on content of the security log.

### (Item 5)

The prover device according to item 2, further includes:
a secure storage unit provided in a secure area; and
a storage control unit configured to control the secure storage unit.

The storage control unit stores the measurement target, which is a target for executing the measurement, in the secure storage unit triggered by the log acquisition unit acquiring the security log.

The measurement unit executes the measurement on the measurement target stored in the secure storage unit.

### (Item 6)

In the prover device according to item 5,

the evidence data transmission unit transmits the measurement target stored in the secure storage unit as the evidence data.

### (Item 7)

In the prover device according to item 6,

the storage control unit deletes the measurement target stored in the secure storage unit after transmitting the measurement target as the evidence data.

### (Item 8)

In the prover device according to item 5,

the measurement result transmission unit transmits the measurement result immediately after the measurement unit executes the measurement.

### (Item 9)

The prover device according to item 5, further includes:
a measurement result request reception unit configured to receive a measurement result request requesting the measurement result from the verification device.

The storage control unit stores the measurement result by the measurement unit in the secure storage unit.

The measurement result transmission unit transmits the measurement result stored in the secure storage unit when the measurement result request reception unit receives the measurement result request.

### (Item 10)

The prover device according to any one of items 1 to 9, further includes:
a measurement instruction reception unit configured to receive a measurement instruction from the verification device, which obtains a security log indicating that the security event has occurred, from the security sensor.

The measurement unit executes the measurement triggered by the measurement instruction reception unit receiving the measurement instruction as the trigger.

### (Item 11)

In the prover device according to item 10, the measurement instruction includes measurement target information indicating a measurement target, which is a target for executing the measurement, and a nonce, and the measurement unit executes the measurement on the measurement target using the nonce.

### (Item 12)

In the prover device according to any one of items 1 to 11, the security sensor is provided in an electronic control unit mounted on a mobile body.

### (Item 13)

In the prover device according to item 12, the prover device is the electronic control unit.

### (Item 14)

In the prover device according to item 12, the prover device includes a first electronic control unit mounted on the mobile body, and the first electronic control unit is different from a second electronic control unit, which is the electronic control unit having the security sensor.

What is claimed is:

1. A prover device in a remote attestation system including a prover device and a verification device, the prover device comprising:
a measurement unit configured to execute measurement using detection of a security event by a security sensor as a trigger;
a measurement result transmission unit configured to transmit a measurement result by the measurement unit to the verification device;
an evidence collection instruction reception unit configured to receive an evidence collection instruction requesting evidence data from the verification device receiving the measurement result; and
an evidence data transmission unit configured to transmit the evidence data to the verification device based on the evidence collection instruction.

2. The prover device according to claim 1, further comprising:
a log acquisition unit configured to acquire a security log indicating occurrence of the security event from the security sensor,
wherein
the measurement unit executes the measurement triggered by the log acquisition unit acquiring the security log as the trigger.

3. The prover device according to claim 2, wherein
the measurement unit determines a measurement target, which is a target for executing the measurement, based on content of the security log.

4. The prover device according to claim 2, wherein
the measurement unit determines whether to execute the measurement based on content of the security log.

5. The prover device according to claim 2, further comprising:
a secure storage unit provided in a secure area; and
a storage control unit configured to control the secure storage unit,
wherein
the storage control unit stores a measurement target, which is a target for executing the measurement, in the secure storage unit triggered by the log acquisition unit acquiring the security log, and
the measurement unit executes the measurement on the measurement target stored in the secure storage unit.

6. The prover device according to claim 5, wherein
the evidence data transmission unit transmits the measurement target stored in the secure storage unit as the evidence data.

7. The prover device according to claim 6, wherein
the storage control unit deletes the measurement target stored in the secure storage unit after transmitting the measurement target as the evidence data.

8. The prover device according to claim 5, wherein
the measurement result transmission unit transmits the measurement result immediately after the measurement unit executes the measurement.

9. The prover device according to claim 5, further comprising:
a measurement result request reception unit configured to receive a measurement result request requesting the measurement result from the verification device,
wherein
the storage control unit stores the measurement result by the measurement unit in the secure storage unit, and
the measurement result transmission unit transmits the measurement result stored in the secure storage unit when the measurement result request reception unit receives the measurement result request.

10. The prover device according to claim 1, further comprising:
a measurement instruction reception unit configured to receive a measurement instruction from the verification device, which obtains a security log indicating that the security event has occurred, from the security sensor,
wherein
the measurement unit executes the measurement triggered by the measurement instruction reception unit receiving the measurement instruction as the trigger.

11. The prover device according to claim 10, wherein
the measurement instruction includes measurement target information indicating a measurement target, which is a target for executing the measurement, and a nonce, and
the measurement unit executes the measurement on the measurement target using the nonce.

12. The prover device according to claim 1, wherein
the security sensor is provided in an electronic control unit mounted on a mobile body.

13. The prover device according to claim 12, wherein
the prover device is the electronic control unit.

14. The prover device according to claim 12, wherein
the prover device includes a first electronic control unit mounted on the mobile body, and
the first electronic control unit is different from a second electronic control unit, which is the electronic control unit having the security sensor.

15. A remote attestation system comprising:
a prover device; and
a verification device,
wherein
the prover device is a device that executes software placed in memory,
the prover device includes:
a measurement unit configured to execute measurement using detection of a security event by a security sensor as a trigger;
a measurement result transmission unit configured to transmit a measurement result by the measurement unit to the verification device;
an evidence collection instruction reception unit configured to receive an evidence collection instruction requesting evidence data from the verification device receiving the measurement result; and
an evidence data transmission unit configured to transmit the evidence data to the verification device based on the evidence collection instruction, and
the verification device is a device that verifies integrity of the software executed by the prover device,
the verification device includes:
a measurement result reception unit configured to receive the measurement result from the prover device;
an evidence collection instruction generation unit configured to generate the evidence collection instruction requesting the evidence data based on the measurement result;
an evidence collection instruction transmission unit configured to transmit the evidence collection instruction to the prover device;
an evidence data reception unit configured to receive the evidence data from the prover device.

16. A proving method executed by a prover device in a remote attestation system including a prover device and a verification device, the proving method comprising:
execute measurement using detection of a security event by a security sensor as a trigger;
transmitting a measurement result by the measurement to the verification device;
receiving an evidence collection instruction requesting evidence data from the verification device receiving the measurement result; and
transmitting the evidence data to the verification device based on the evidence collection instruction.

17. A non-transitory computer readable storage medium storing a proving program executable by a prover device in a remote attestation system including a prover device and a verification device, the proving program comprising instructions configured to, when executed by at least one processor, cause the prover device to:
execute measurement using detection of a security event by a security sensor as a trigger;
transmitting a measurement result by the measurement to the verification device;
receiving an evidence collection instruction requesting evidence data from the verification device receiving the measurement result; and
transmitting the evidence data to the verification device based on the evidence collection instruction.
